(19) United States
(12) Patent Application Publication
(10) Pub. No.: US 2011/0228305 A1
(43) Pub. Date: Sep. 22, 2011

(54) MULTIFUNCTION PERIPHERAL SELECTING APPARATUS AND MULTIFUNCTION PERIPHERAL SELECTING METHOD

(75) Inventor: Naoko SASASE, Itami-shi (JP)

(73) Assignee: Konica Minolta Business Technologies, Inc., Chiyoda-ku (JP)

(21) Appl. No.: 13/048,141

(22) Filed: Mar. 15, 2011

(30) Foreign Application Priority Data
Mar. 19, 2010 (JP) 2010-065036

(51) Int. Cl. G06F 3/12

(52) U.S. Cl. 358/1.13

(57) ABSTRACT

A multifunction peripheral selecting apparatus for selecting a multifunction peripheral which is capable of controlling a power supply condition to a plurality of units and executing a plurality of functions each requiring different units, including: an acquisition section which acquires the power supply condition by each of the plurality of units of the multifunction peripheral; a memory section which previously stores required unit information indicating a correspondence relation between a function and units required for executing the function; an input section which receives a designation of the function; a selection section which selects a suitable multifunction peripheral for executing the designated function from a plurality of managed multifunction peripherals, based on an acquisition result by the acquisition section and the required unit information stored in the memory section; and a notification section which notifies a user of the selected suitable multifunction peripheral.

### CROSS REFERENCE TO RELATED APPLICATION

The present application is based on Japanese Patent Application No. 2010-065036 filed with Japanese Patent Office on Mar. 19, 2010, the entire content of which is hereby incorporated by reference.

### BACKGROUND OF THE INVENTION

1. Technical Field

The present invention relates to a multifunction peripheral selecting apparatus and a multifunction peripheral selecting method for selecting a multifunction peripheral (herein after referred also as MFP) from a plurality of multifunction peripherals, each having a plurality of functions.

2. Description of Prior Arts

In recent years, a requirement of power saving is growing for a printer or an MFP installed in an office, and a function of automatically transit to a power saving mode, where power consumption is less than a usual mode, is realized in cases where a standby state of no executing job or no user's operation continues more than a prescribed time period.

In order to further improve the power saving effect, a power saving control is executed where power supply conditions to a plurality of units are made individually controllable. Wherein, in a case of executing a specified function, power is supplied to a unit necessary for executing the function and the power to unnecessary unit is stopped.

Regarding this power supply control for individual unit, for example, Unexamined Japanese Patent Application Publication No. 2002-283656 (Patent Document 1) discloses a technology where an LED corresponding to each unit is provided on an operation panel, and the power supply condition for each unit is displayed with the LED to notify the user.

Unexamined Japanese Patent Application Publication No. 2008-166908 (Patent Document 2), in view of a fact that a certain period is required for recovering from the power saving mode, proposes a technology where a function to be quickly used is previously set, and the power supply to the function is continued in case of transition to the power saving mode.

Unexamined Japanese Patent Application Publication No. 2006-173695 (Patent Document 3), in view of a fact that if the power supply control for individual unit is configured with a relatively large power consumption CPU power saving effect is decreased even when executing the power supply control for individual unit, a power supply control technology is disclosed, where a switch section with less power consumption than the CPU is provided and the switch section controls the power supply to the CPU and each unit.

Further, Unexamined Japanese Patent Application Publication No. 2008-153770 (Patent Document 4), a power supply control technology is disclosed, where a unit allowed to be used by each user is previously registered, and the power supply to the unit not allowed for the user is stopped when the user logged in.

In cases where a plurality of MFPs controllable of power supply by individual units are installed in an office, conditions where the unit being supplied with power is different by each multifunction apparatus, namely the conditions occur where the function usable in the present power supply condition is different by each MFP.

In these cases, for an example of print job, as a job input destination, selecting the MFP whose print unit has been already power supplied is preferable than the MFP whose print unit is not presently supplied power, from the view points of power saving effect and recovering time reduction.

However, all the technology disclosed by Patent Documents 1-4 relating to the power supply control by individual units aim to improve the power saving effect or convenience of the apparatus itself, and it is not usable to select a suitable MFP from a plurality of MFPs controllable of power supply by individual units from the view points of power saving effect and recovering time reduction.

An object of the present invention is to solve the above mentioned problems and to provide an MFP selecting apparatus and an MFP selecting method for selecting an MFP apparatus as a job input destination from a plurality of MFPs controllable of power supply by individual units, from the view points of power saving effect and recovering time reduction.

### SUMMARY

To achieve at least one of the abovementioned objects, a multifunction peripheral selecting apparatus reflecting one aspect of the present invention is:

(1) An multifunction peripheral selecting apparatus for selecting a multifunction peripheral which is capable of controlling a power supply condition to a plurality of units and executing a plurality of functions each requiring different units, the multifunction selecting apparatus including: an acquisition section which acquires the power supply condition by each of the plurality of units of the multifunction peripheral; a memory section which previously stores required unit information indicating a correspondence relation between a function and units required for executing the function; an input section which receives a designation of the function; a selection section which selects a suitable multifunction peripheral for executing the designated function from a plurality of the multifunction peripherals, which are subjects to be controlled, based on an acquisition result by the acquisition section and the required unit information stored in the memory section; and a notification section which notifies a user of the selected suitable multifunction peripheral.
(2) In the multifunction peripheral selecting apparatus of above (1), it is preferable for the selection section to select, as the suitable multifunction peripheral, a multifunction peripheral in which every unit required for executing the designated function is supplied with electric power.
(3) In the multifunction peripheral selecting apparatus of above (1), it is preferable for the notification section to execute the notification by presenting to a user with a list of the plurality of multifunction peripherals, the list including information of whether each of the multifunctional peripheral is supplied with the electric power to every unit required for executing the designated function.
(4) In the multifunction peripheral selecting apparatus of above (1), in cases where plural multifunction peripherals which are supplied with the electric power to every unit required for executing the designated function are available, it is preferable for the notification section to notify the user of the plural multifunction peripherals with the less priority order of a multifunction peripheral which has the more functions for which the electric power is supplied to every required unit.
(5) In the multifunction peripheral selecting apparatus of above (1), in cases where plural multifunction peripherals which are not supplied with the electric power to any unit required for executing the designated function are available, the notification section preferably notifies the user of the plural multifunction peripherals with the less priority order of a multifunction peripheral which has the more required units which are not supplied with the electric power.
(6) In the multifunction peripheral selecting apparatus of above (1), in cases where plural multifunction peripherals which are not supplied with the electric power to any unit required for executing the designated function are available, it is preferable for the multifunction peripheral selecting apparatus to give a weighting factor to each of the required unit, obtain sum total of the weighting factor by each of the plural multifunction peripherals, and execute the notification with a priority order based on the sum total of the weighting factor.
(7) In the multifunction peripheral selecting apparatus of above (1), it is preferable for a terminal apparatus, connected via a network to the multifunction peripheral selecting apparatus, to receive the designation, and the notification is executed on a display screen of the terminal apparatus having received the specification.

### BRIEF DESCRIPTION OF THE DRAWINGS

These and other objects, advantages and features of the invention will become apparent from the following description thereof taken in conjunction with the accompanying drawings in which:

FIG. 1 is a drawing illustrating a system configuration of an MFP system having a function of an MFP selecting apparatus relating to the first embodiment of the present invention;

FIG. 2 is a block diagram showing an outline configuration of an MFP;

FIG. 3 is a block diagram showing an outline configuration of an information processing apparatus;

FIG. 4 is a drawing illustrating a table of required units by each function;

FIG. 5 is a drawing illustrating an example of power condition table;

FIG. 6 is a drawing illustrating an MFP selection operation sequence in an MFP system of the first embodiment;

FIG. 7 is a flow diagram showing operations of the information processing apparatus in the operation sequence of FIG. 6;

FIG. 8 is a flow diagram showing a recommended MFP selection process corresponding to step 104 of FIG. 7;

FIG. 9 is a drawing illustrating an example of recommended MFP list formed by the recommended MFP selection process of FIG. 8;

FIG. 10 is a drawing illustrating a system configuration of an MFP system relating to the second embodiment;

FIG. 11 is a drawing illustrating an example of usable function table;

FIG. 12 is a drawing illustrating an MFP selection operation sequence in an MFP system of the second embodiment;

FIG. 13 is a flow diagram showing the second recommended MFP selection process;

FIG. 14 is a drawing illustrating an example of recommended MFP list formed by the second recommended MFP selection process;

FIG. 15 is a drawing illustrating a system configuration of an MFP system relating to the third embodiment;

FIG. 16 is a drawing illustrating an MFP selection operation sequence in an MFP system of the third embodiment;

FIG. 17 is a flow diagram showing operations of the information processing apparatus in the operation sequence of FIG. 16;

FIG. 18 is a drawing illustrating a system configuration of an MFP system relating to the fourth embodiment;

FIG. 19 is a drawing illustrating an MFP selection operation sequence in an MFP system of the fourth embodiment;

FIG. 20 is a flow diagram showing operations of the information processing apparatus in the operation sequence of FIG. 19;

FIG. 21 is a drawing illustrating a system configuration of an MFP system relating to the fifth embodiment;

FIG. 22 is a drawing illustrating an MFP selection operation sequence in an MFP system of the fifth embodiment;

FIG. 23 is a flow diagram showing operations of the information processing apparatus in the operation sequence of FIG. 22;

FIG. 24 is a drawing illustrating a system configuration of an MFP system relating to the sixth embodiment;

FIG. 25 is a block diagram showing an outline configuration of a management server;

FIG. 26 is a drawing illustrating an MFP selection operation sequence in an MFP system of the sixth embodiment;

FIG. 27 is a drawing illustrating an example of a second table of required units by each function;

FIG. 28 is a drawing illustrating an MFP selection operation sequence in an MFP system of the seventh embodiment;

FIG. 29 is a drawing illustrating an example of usable function table;

FIG. 30 is a drawing illustrating an MFP selection operation sequence in an MFP system of the eighth embodiment;

FIG. 31 is a drawing illustrating an example of power condition table provided with power recovery factors;

FIG. 32 is a flow diagram showing the third recommended MFP selection process;

FIG. 33 is a drawing illustrating an example of sum total list of power recovery factors;

FIG. 34 is a drawing illustrating an example of user factors; and

FIG. 35 is a flow diagram showing the fourth recommended MFP selection process.

### DETAILED DESCRIPTION OF THE PREFERRED EMBODIMENTS

Hereinafter, various types of embodiments of the present invention will be described.

### First Embodiment

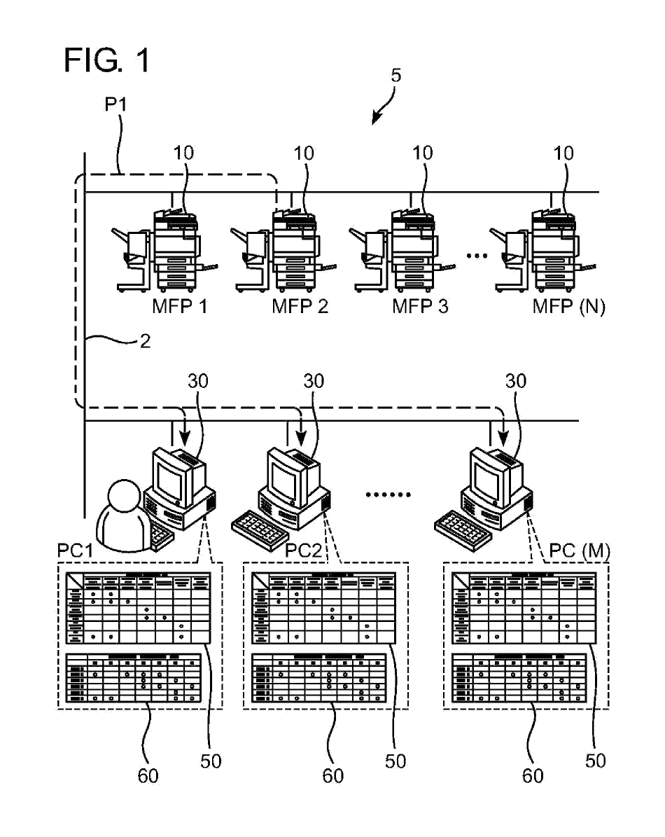

FIG. 1 is a drawing illustrating a system configuration of an MFP system having a function of an MFP selecting apparatus relating to the first embodiment of the present invention. MFP system 5 is configured of a plurality of MFP 10, and a plurality of information processing apparatus (hereinafter referred also as PC) 30 such as a personal computer connected with network 2 such as a LAN (Local Area Network).

MFP 10 is an image forming apparatus provided with a plurality of functions such as a copy function of optically reading an original document and printing its duplication image on a recording sheet, a scanning function of filing and storing image data of the read image and transmitting the image data to an external terminal via network 2, a print function of forming the image relating to print data received via network 2 from information processing apparatus 30 on the recording sheet for outputting, and a FAX function of transmitting and receiving the image data by facsimile. Further, MFP 10 is configured to be capable of controlling the power supply conditions to a plurality of functional units by each of the functional unit. Each of the above functions is executed by activating the functional unit respectively required for each function.

MFP system 5 provides an MFP recommendation function that detects the power supply condition of each MFP 10 connected to network 2, and selects MFP 10 in which electric power is supplied to all the functional units required for executing the function specified by a user, and recommends the selected MFP 10 to the user as a subject of executing the job, or automatically transmits the job to the selected MFP 10.

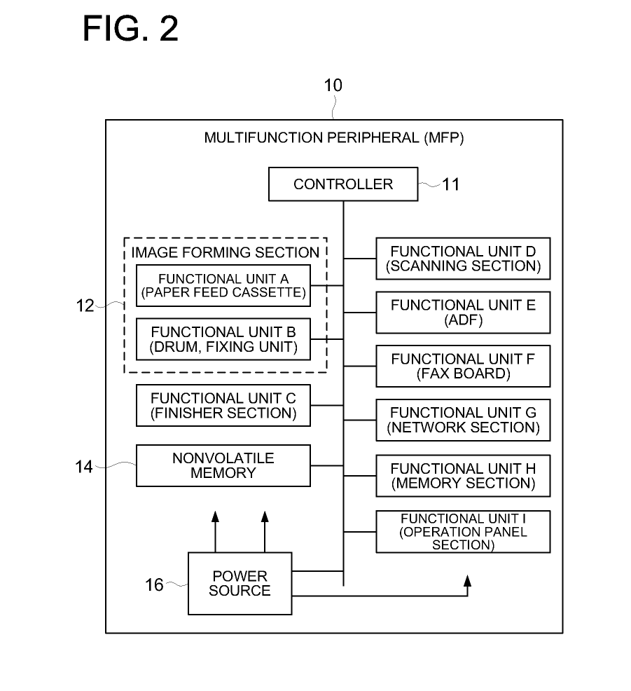

FIG. 2 illustrates an outline configuration of MFP 10. MFP 10 is provided with controller 11 for totally controlling the movements of said MFP 10, a various functional units A-I being controlled by controller 11, a nonvolatile memory 14, and a power source 16 for supplying electric power to controller 11 and each functional unit.

Controller 11 is configured with such as CPU (Central Processing Unit), ROM (Read Only Memory) and RAM (Random Access Memory) as the main components, and the CPU executes the processing based on various programs stored in the ROM to realize each function of the MFP 10.

Image forming section 12 for forming an image on a recording sheet and outputting the recording sheet is configured with including functional unit A and functional unit B. Functional unit A performs a function of detecting the size of recording sheet accommodated in a paper feed cassette, and feeding out and conveying the recording sheet accommodated in the sheet feed cassette. Functional unit B performs a function of forming and fixing an image on the recording sheet conveyed by the functional unit A. Functional unit B is provided with a photosensitive drum, a charging device, a laser unit, a developing device, transfer and separation device, and a fixing unit to perform the image formation through an electrophotographic process.

Functional unit C performs a function of finisher section to apply various post-processing such as punching, stapling, folding to the recording sheet ejected from image forming section 12.

Functional unit D (scanning section) performs a function of optically reading an original document to obtain image data. Functional unit E is an automatic document feeder (ADF), and sequentially feeds out a set of original documents on an original platen one by one, and conveys through the reading position by functional unit D toward a sheet ejection tray.

Functional unit D is provided with a function of reading the original document having been set on the platen grass, in addition to sequentially reading the original document conveyed by functional unit E. Functional unit D, for example, is configured with a light source to irradiate light to the original document, a line image sensor to receive the reflected light from the original document and read per one line in width direction of the document, a moving section to sequentially move the reading position of the line image sensor by each line unit along the back surface of the platen grass in the longitudinal direction of the original document, a optical path including a lens and a mirror to guide and focus the reflected light from the original document, a conversion section to convert analogue image signals outputted from the line image sensor into digital image data, and the like.

Functional unit F (FAX board) is configured with various circuits for performing transmitting and receiving of facsimile. Functional unit F (FAX board) executes encoding/decoding of image data, calling, calling-in and protocol control of facsimile communication, and the like.

Functional unit G (network section) performs a function of transmitting and receiving the various data through network 2 with information processing apparatus 30, other information processing apparatus 30, management server 90 (to be described later), and the like.

Functional unit H (memory section) is a large capacity nonvolatile memory device to be used for storing, for example, the print data or the image data read out by the scanning function.

Functional unit I (operation panel section) is an operation panel to display various operation screens or setting screens, and to receive various operations such as a job input and setting by a user. Functional unit I is configured with an operation section provided with a display section such as a liquid crystal display (LCD), a touch panel which is arranged on the LCD to detect the coordinates of pushed position, and various keys such as a numerous keypad, character input keys, and a start key.

In nonvolatile memory 14, system information, user information and the like are memorized. In the system information, IP address, apparatus name of the MFP are included.

Power source 16 converts electric power from a commercial electric power source to proper voltage and supplies to each section of MFP 10. Further power source 16 is provided with a function of controlling whether to supply or stop to supply the electric power by each functional unit, base on an instruction of controller 11. In MFP 10, in the case of executing a certain function, the electric power is supplied only to the unit necessary for executing the function. Further MFP 10 is configured such that to the unit once supplied the electric power supply is continued for a preset time period (for example 10-30 minutes) after the completion of the job of using the unit, and if the unit is not used during said time period, the power supply to said unit is stopped or MFP 10 enters in a power saving mode. Wherein, the condition where power supply is stopped or the condition of the power saving mode is assumed to be a sleep condition, and resuming the power supply from the sleep condition is assumed to be sleep release.

Functional unit G and functional unit I are configured to receive power supply from a sub power source (not illustrated) and able to receive data from externals and receive a return trigger of user's operation and the like, even in the sleep condition of not being supplied of electric power.

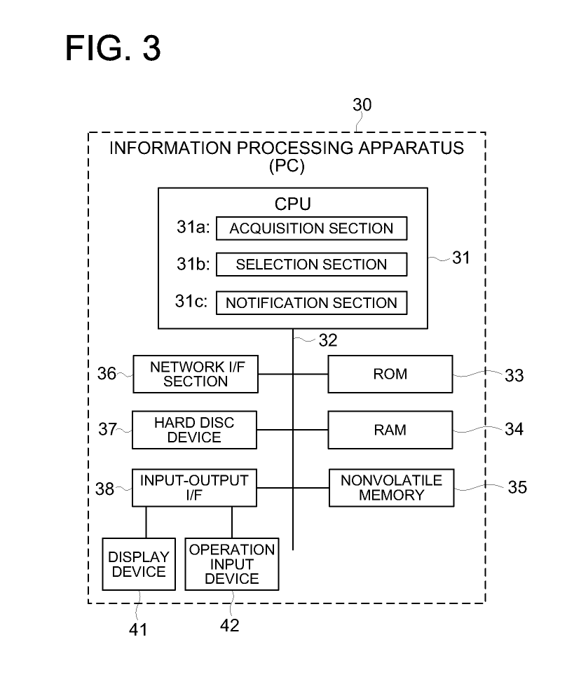

FIG. 3 shows an outline structure of an example of information processing apparatus 30. Information processing apparatus 30 is provided with a function of inputting jobs such as a scanning job and a print job to MFP 10 and asking to execute the jobs. Information processing apparatus is a personal computer and the like installed with an OS program, driver program of MFP 10, and application programs to create a document or an image.

Information processing apparatus 30 is provided with CPU 31, which includes acquisition section 31a, selection section 31b, and notification section 31c. CPU 31 is connected via bus 32 to ROM 33, RAM 34, nonvolatile memory 35, network I/F section 36, hard disc device 37, input-output I/F 38, and the like. Further, via input-output I/F 38, CPU 31 is connected to display device 41 such as a liquid crystal display, operation input device 42 such as a keyboard and a mouse.

In ROM 33, an activation program and fixed data are stored. RAM 34 memorizes a program loaded from hard disk device 37. Further, RAM 34 is utilized as a work memory to temporarily store various data in cases where CPU 31 executes a program.

Nonvolatile memory 35 is a memory whose stored content is not destroyed even in case of power off, and stores system information of said information processing apparatus 30 (name, and address), user's information, various types of setting information, and the like.

Network I/F section 36 performs a function of transmitting and receiving various data to and from an external apparatus such as MFP 10 and other information processing apparatus 30 via network 2. Hard disc device 37 is a large capacity memory device, and stores an OS program, a driver program of MFP 10, various application programs, a file, data, and the like.

In MFP system 5 relating to the first embodiment, in cases where each MFP 10 transforms a power condition (electric power supply condition) of own apparatus, MFP 10 notifies a power condition of each function unit after the transformation to every information processing apparatus 30 of controlled object. Then, driver program of information processing apparatus 30 selects a suitable MFP 10 for executing the specified function by a user, and recommends to the user.

More specifically, as shown in FIG. 1, each information processing apparatus 30 stores a table of required units by each function 50 which shows by correlating each function of MFP 10 and a functional unit required to execute the function, in nonvolatile memory 35 for example. In cases where a power condition of own apparatus is changed, MFP 10 transmits the information showing the power condition of each function unit after the transformation to every information processing apparatus 30 (P1). Each information processing apparatus 30 stores power condition table 60 in which a power condition of each unit is registered by each MFP 10 in non volatile memory 35 (memory section) for example, and acquires at acquisition section 31a the power condition information transmitted from MFP 10 to update power condition table 60 based on the acquired information.

Then, in cases where selection section 31b of information processing apparatus 30 receives specification of a function required of executing by a user, via operation input device 42, selection section 31b determines the required functional unit for executing the specified function from table of required units by each function 50, and selects an MFP 10 in which all those required functional unit are not in sleep condition, by referring to the power condition table 60 updated in the own apparatus. After that, notification section 31c displays the selected MFP 10 on display device 41 of its own apparatus, or automatically transmits the job to the selected MFP 10. Here, operations of information processing apparatus 30 relating to the selection of MFP is mainly executed by a driver program of MFP 10 installed in said information processing apparatus 30.

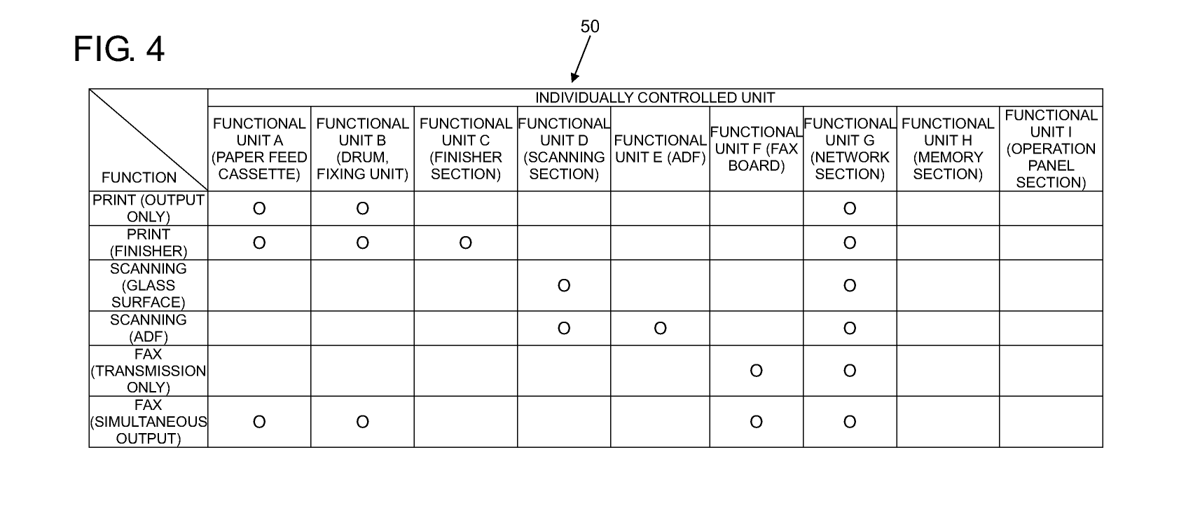

FIG. 4 is a drawing illustrating an example of a table of required units by each function 50. Functions registered in table of required units by each function 50 are relating to jobs capable of being inputted to MFP 10 from information processing apparatus 30, the functions including print (output only), print (finisher), scanning (grass surface), scanning (ADF), FAX (transmission only), and FAX (simultaneous output). In table of required units by each function 50, at a column of required functional unit for executing the function a circle mark (∘) is given.

Regarding the function of print (output only), functional unit A, functional unit B, and functional unit G, are used, and image forming section 12 executes the print based on the print data received from information processing apparatus 30. Regarding the function of print (finisher), functional unit A, functional unit B, functional unit C, and functional unit G, are used, and image forming section 12 executes the print based on the print data received from information processing apparatus 30, and further, post-processing such as punching, stapling, and folding is executed to the printed material.

Regarding the function of scanning (grass surface), functional unit D, functional unit E, and functional unit G, are used, an original document placed on the platen grass is read out, and the image data is transmitted to an external apparatus such as information processing apparatus 30 via network 2. Regarding the function of scanning (ADF), functional unit D, functional unit E, and functional unit G are used, one or a plurality of original document sheets conveyed by an automatic document feeder is sequentially read, and the image data is transmitted to an external apparatus such as information processing apparatus 30 via network 2.

Regarding the function of FAX (transmission only), functional unit F, and functional unit G, are used, and the image data received from information processing apparatus 30 is sent by facsimile transmission to the specified destination. Regarding the function of FAX (simultaneous output), functional unit A, functional unit B, functional unit F and functional unit G are used, and the image data received from information processing apparatus 30 is printed out by image forming section 12 in addition to be sent by facsimile transmission to the specified destination.

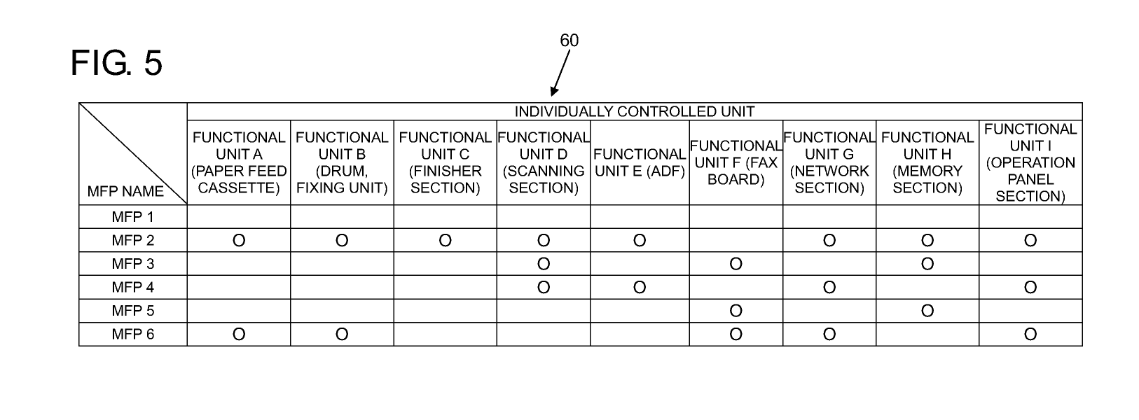

FIG. 5 shows an example of power condition table 60. In power condition table 60, a power supply condition of each functional unit by each MFP 10 is registered. A circle mark (∘) in the figure shows that electric power is supplied.

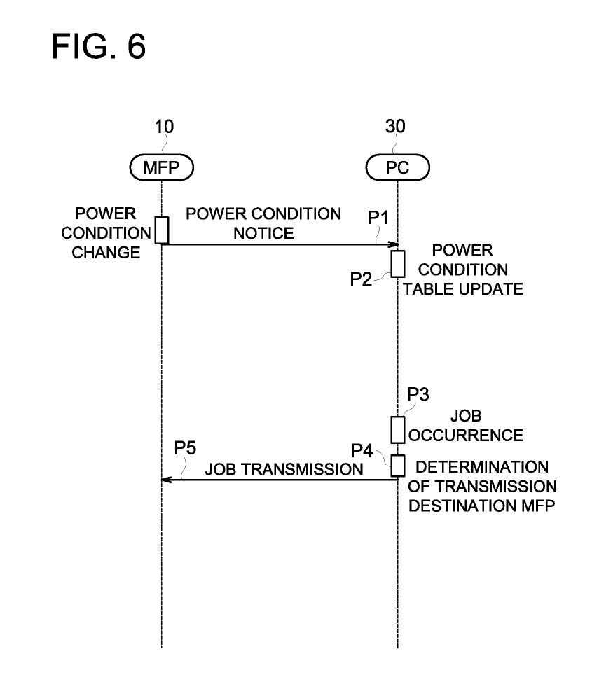

FIG. 6 is a drawing illustrating an MFP selection operation sequence in MFP system 5 of the first embodiment. In cases where a power condition of own apparatus is changed, MFP 10 transmits the power condition information showing the power condition (electric power supply condition by each functional unit) of each function unit after the change to every information processing apparatus 30 of all controlled objects (P1). The power condition information may be the information to show the conditions of every functional units, or may be the information to show only changed parts in case of after notifying once the conditions of every functional units. In order to receive the power condition information whose time of being sent is unknown, information processing apparatus 30 is always installed with the receiving program in the side of its own apparatus.

Information processing apparatus 30 received of the power condition information updates power condition table 60 stored in its own apparatus based on the content of received information (P2). When receiving a setting operation for a job to be executed by MFP 10 (P3), information processing apparatus 30 determines a suitable MFP 10 for the destination of sending the job, based on the required units by each function table 50 stored in its own apparatus, power condition table 60 and the type (function) of the job (P4). And, information processing apparatus 30 transmits the job to the determined MFP 10 (P5).

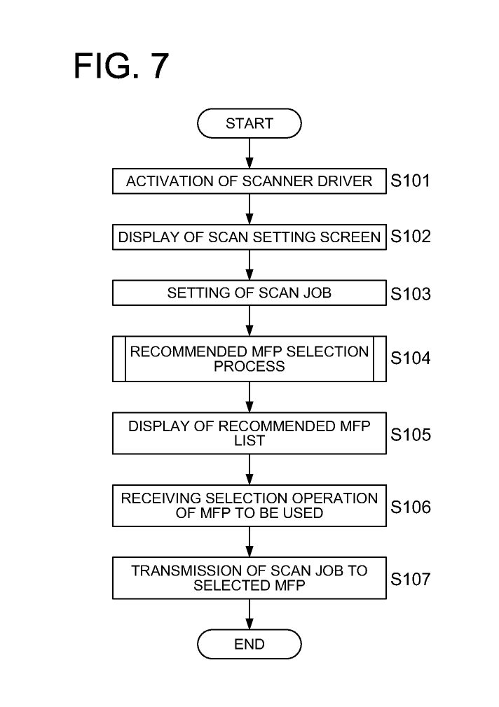

FIG. 7 is a flow diagram showing operations of the information processing apparatus 30 in the operation sequence of FIG. 6. Here, cases where a scanning job such as the scanning (grass surface) or the scanning (ADF) is inputted. When receiving an activation request of a scanner driver of MFP 10 from a program such as an image editing application, CPU 31 activates the corresponding scanner driver (step S101).

CPU 31 for executing the scanner driver displays a scanner setting screen (step S102) on display device 41 of information processing apparatus 30 in order to receive various settings regarding the scanning job. After completion of accepting the settings on the scanner setting screen, a recommended MFP selection process is executed (step S104), in order to select an MFP 10 suitable for the accepted job type (specified function). In the recommended MFP selection process, a recommended MFP list is formed where a plurality of MFP 10 are arranged in a view in recommended order. Details of the recommended MFP selection process will be described later.

CPU 31 displays the recommended MFP list formed by the recommended MFP selection process on display device 41 (step S105). The user determines an MFP 10 by reference of the displayed recommended MFP list. CPU 31 receives a selection operation of MFP 10 for job transmitting destination (step S106), and transmits the scanning job having been set in step S103 toward the selected MFP 10 (step S107) to conclude the process.

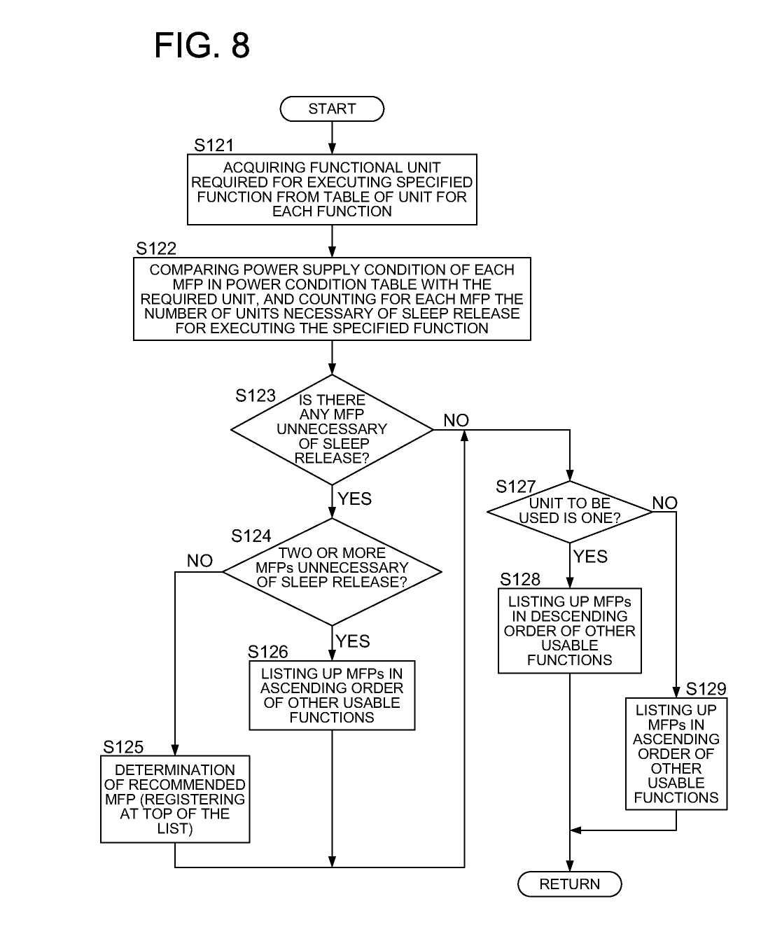

FIG. 8 is a flow diagram showing a recommended MFP selection process (the first MFP selection process) corresponding to step 104 of FIG. 7. CPU 31 acquires a functional unit required for executing the specified function from the required units by each function table 50 (step S121). Subsequently, from the power condition by each functional unit registered in the required units by each function table 50, counts the number of units necessary of sleep release for executing the specified function, for each MFP registered in the power condition table 60 (step S122).

For example in cases where the specified function is “scanning (ADF)”, required units are found to be functional unit D and functional unit E from the required units by each function table 50. And, in the case where power condition table 60 is in the state shown in FIG. 5, the number of unit necessary of sleep release is counted to be 2 for MFP1, 0 for MFP2, 1 for MFP 3, 0 for MFP4, 2 for MFP5, and 2 for MFP6.

Subsequently, CPU31 judges whether MFP 10 which is not necessary of sleep release (the number of functional unit necessary of sleep release is 0) exists or not (FIG. 8: step S123). In the case where MFP 10 unnecessary of sleep release is available (step S123; Yes) and the number of apparatus is one (step S124; No), CPU 31 determines said MFP 10 unnecessary of sleep release as the most recommended MFP 10, and registers it at the top of the recommended MFP list (step S125), and moves to step S127.

In cases where, two or more MFP 10 unnecessary of sleep release are available (step S124; Yes), these MFP 10 are listed in ascending order of other usable function number (step S126), and the process moves to step S127.

In the above described example, two of MFP2 and MFP4 are MFP10 unnecessary of sleep release. And by comparing the power supply conditions of MFP2 and MFP4, with required function unit table by each function 50, it is found that MFP2 can use other four functions (print: output only, print: finisher, scanning: grass surface, and scanning: ADF), and MFP4 can use the other one function (scanning: grass face). Therefore the recommended order is MFP4 to MFP2.

To put higher priority to MFP 10 having fewer other usable functions is due to a reason that MFP10 having the other usable function is preferably left for other user requiring to use said other function.

In step S125 or step S126, after registering the MFP unnecessary of sleep release in the MFP recommended list, or in the case where MFP 10 unnecessary of sleep release is not available (step S123; No), it is checked whether required functional unit for executing the specified function is one or not (step S127). In case of the required unit being one (step S127; Yes), the MFP 10 unregistered in the recommended MFP list is sorted in descending order of number functions becoming usable in case of said one functional unit being released from sleep mode, and registered in the recommended MFP list (if there is one already registered, additionally registered subsequently to the one), and the process completes (return).

In cases where there are two or more functional unit required for executing the specified function (step S127; No), the MFP 10 unregistered in the recommended MFP list is registered in the recommended MFP list, in ascending order of number functional unit to be released from the sleep mode (if there is one already registered, additionally registered subsequently to the one), and the process completes (return).

For example in the above described case, since the functional units to be used are two (functional unit D and functional unit E), the process goes to step S129. Among MFPs unregistered in the recommended list MFP1, MFP3, MFP5, and MFP6, the one having least number of functional unit necessary of sleep release is MFP3, and other MFPs have the same two functional unit. Therefore next recommended order is for MFP3. Among the MFPs having same functional unit necessary of sleep release, the recommended order is decided by the criteria of S128. As the result, MFP6, MFP5, MFP1 are decided in that order of recommendation in the present case.

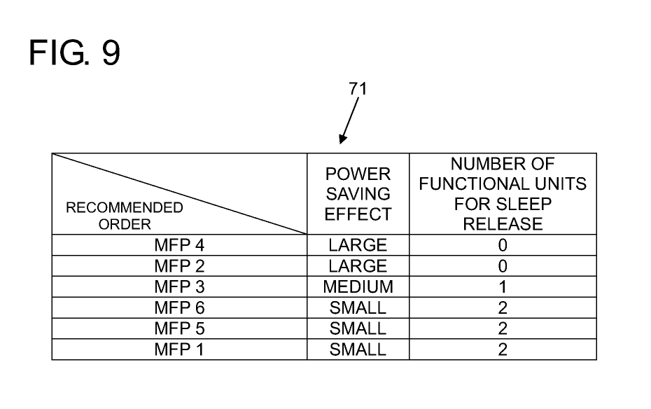

FIG. 9 shows an example of display on display device 41, in the case where the recommended MFP list formed by the recommended MFP selection process of FIG. 8. Here, MFP 10 are listed in recommended order, and also, large or small effect of power saving in the case of executing the specified function by using the MFP 10 and number of functional unit necessary of sleep release are displayed in correlation by each MFP 10.

Further, CPU 31 of information processing apparatus 30 may be configured to automatically decide the MFP 10 of the highest recommended order as the destination of job transmission, and automatically or after receiving user's consent, transmit the job to said MFP 10.

In this way, MFP system 5 relating to the first embodiment, in executing the specified function, recommends the MFP 10 unnecessary of sleep release or the MFP 10 having small number of functional unit necessary of functional release in executing the specified function as an execution apparatus of the job relating to the specified function, or automatically selects said MFP 10 and transmits the job to said MFP 10. Therefore, the user is enabled to select the suitable MFP among the plurality of MFP 10 connected to the network from the view points of power saving effect, reducing the recovery time, and the like, and to input the job to the selected MFP. Namely, unnecessary recovery of MFP from sleep mode is prevented and MFP 10 can be effectively used. Further users can easily select the most quickly usable MFP 10 for desired function.

Further, since information processing apparatus 30 forms recommended MFP list, burden share to MFP 10 is small. In addition, by the time of power condition change the power condition information is sent from MFP 10 to each information processing apparatus 30, and power condition table 60 in information processing apparatus 30 is always updated to the latest condition, therefore at an occurrence of job, information processing apparatus 30 can rapidly select the recommended MFP by referring to power condition table stored in itself.

### Second Embodiment

The MFP system relating to the second embodiment is configured such that in cases where MFP 10 has changed its own power condition, MFP 10 notifies of a function usable by its own apparatus after changing the power condition to each of information processing apparatus 30. Hereinafter, the description relating to the same parts as the first embodiment will be arbitrarily omitted.

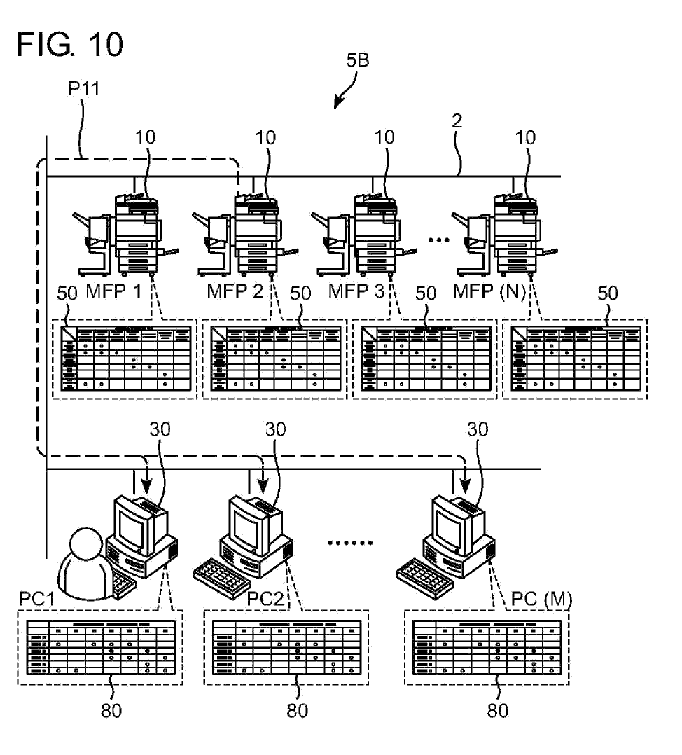

FIG. 10 is a drawing illustrating a system configuration of an MFP system 5B relating to the second embodiment. Each information processing apparatus 30 stores table of required units by each function 50 same as the one of FIG. 4, for example, in nonvolatile memory 14. Each MFP 10 stores usable function table 80 for registering the information regarding the usable function notified from MFP 10.

In case of changing the power condition, MFP 10 determines the function usable by its own apparatus after the change based on table of required units by each function 50, and notifies to each information processing apparatus 30 (P11). On receiving the notification, information processing apparatus 30 updates the usable function table 80 stored in its own apparatus based on the content of received notification. In case of receiving the specification of desired function (job setting) from a user, information processing apparatus 30 selects a suitable MFP 10 for executing the job. Then, information processing apparatus 30 displays the selected MFP 10 on its display device to notify the user, or automatically transmits the job to the selected MFP 10.

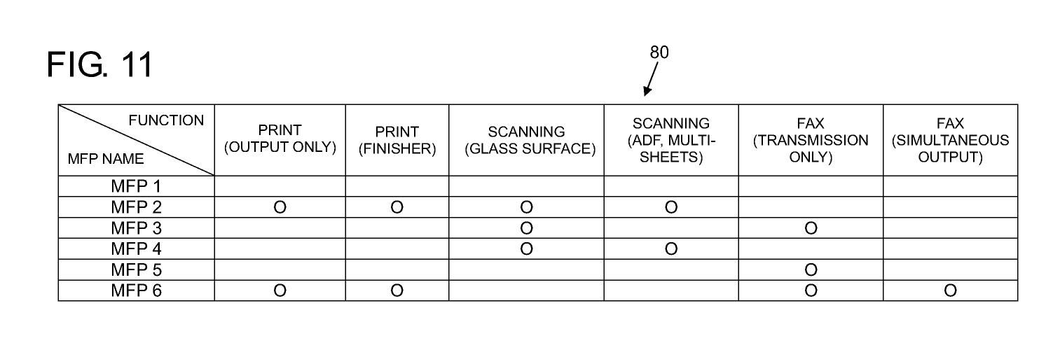

FIG. 11 shows an example of usable function table 80. In usable function table 80, usable functions (job type) in the present power condition are registered by each MFP 10. In the figure, ∘ mark indicates that the function is usable. As the functions, print (output only), print (finisher), scanning (grass surface), scanning (ADF), FAX (transmission only), FAX (simultaneous output), and the like are available.

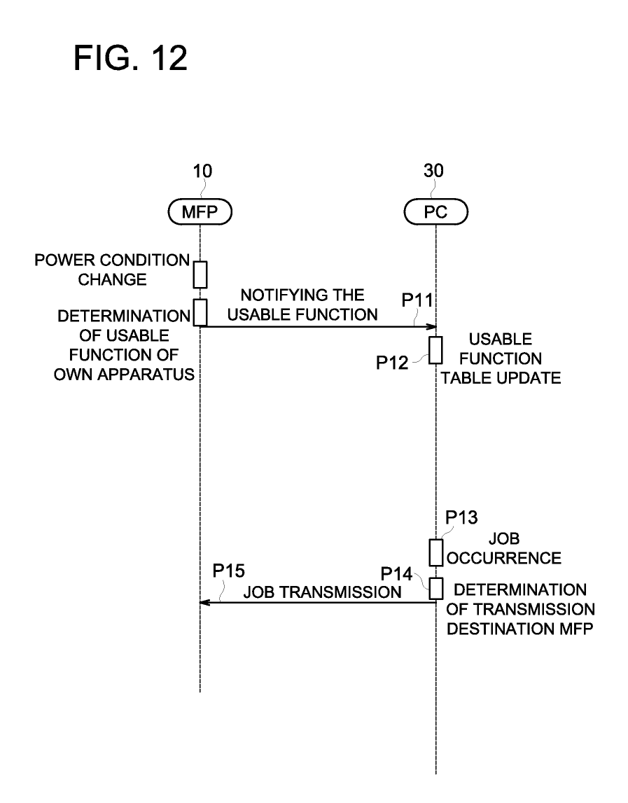

FIG. 12 is a drawing illustrating an MFP selection operation sequence in MFP system 5B of the second embodiment. In cases where a power condition of own apparatus is changed, MFP 10 determines the usable function by comparing the power condition after change (electric power supply condition by each functional unit) and the table of required units by each function 50, and transmits the usable function information indicating the usable function to every information processing apparatus 30 of all controlled objects (P11). The usable function information may be the information to show the conditions of every function, or may be the information to show only changed parts in case of after notifying once the conditions of every function.

Information processing apparatus 30 received of the usable function information updates the usable function table 80 stored in its own apparatus based on the content of received information (P12). When receiving a setting operation for a job to be executed by MFP 10 (P13), information processing apparatus 30 determines a suitable MFP 10 for the destination of sending the job, based on the usable function table 80 stored in its own apparatus, and the type (function) of the job (P14). And, information processing apparatus 30 transmits the job to the determined MFP 10 (P15).

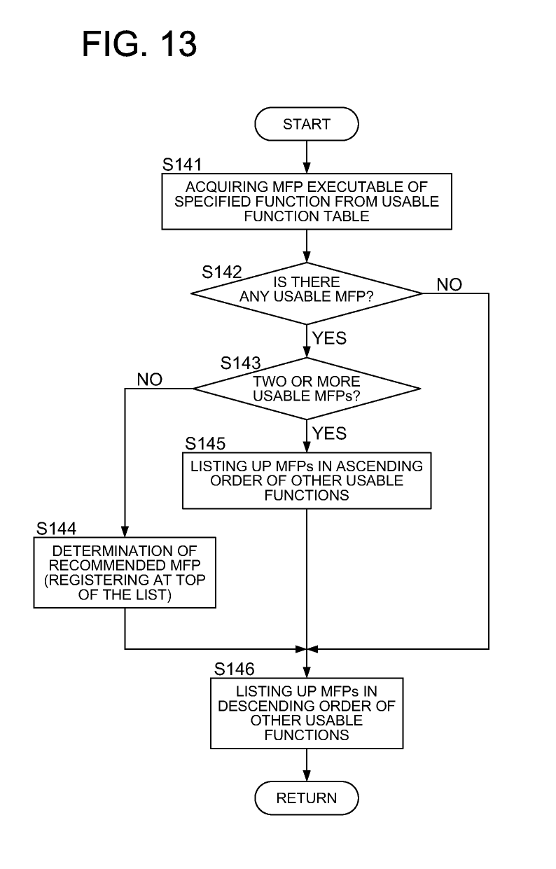

Outline of the operation of information processing apparatus 30 in the operation sequence of FIG. 12 is similar to the one shown in FIG. 7. However, in step S104 the second recommended MFP selection process shown in FIG. 13 is executed in place of the recommended MFP selection process shown in FIG. 8.

As shown in FIG. 13, in the second recommended MFP selection process, CPU 31 acquires a usable MFP 10 for the specified function from the usable function table 80 stored in its own apparatus (step S141). For example in the case where the specified function is “scanning (ADF)”, CPU 31 determines the usable MFP 10 of MFP2 and MFP4 from the usable function table 80 in FIG. 11.

In the case where only one MFP 10 is available as the usable MFP of the specified function (FIG. 13: step S142; Yes, S143; No), CPU 31 determines said MFP 10 as the recommended MFP and registers it at the top of recommended MFP list (step S144), and the process goes to step S146.

In cases where, two or more MFP 10 usable of the specified function (step S143; Yes), these MFP 10 are listed in ascending order of other usable function number (step S145), and the process moves to step S146. In the above described example, MFP2 has three other usable function of print (output only), print (finisher) and scanning (grass surface), and MFP4 has one other usable function, therefore the recommended order becomes MFP2, MFP4 in this order.

To put higher priority to MFP 10 having fewer other usable functions is due to a reason that MFP10 having the more other usable functions is preferably left for other user requiring to use said other function.

In step S144 or step S145, after registering in the MFP recommended list, or in the case where MFP 10 usable of the specified function is not available (step S142; No), the unregistered MFPs are registered in descending order of the number of other usable functions in the recommended MFP list (if there is one already registered, additionally registered subsequently to the one), (step S146) and the process completes (return).

For example in the above described case, when the process comes to step S146, the MFPs 10 having not been registered in the recommended list are MFP1, MFP3, MFP5, and MFP6. By arranging these MFPs in descending order of usable function number with reference to the usable function table 80, MFP6, MFP3, MFP5, and MFP1 are obtained in this order.

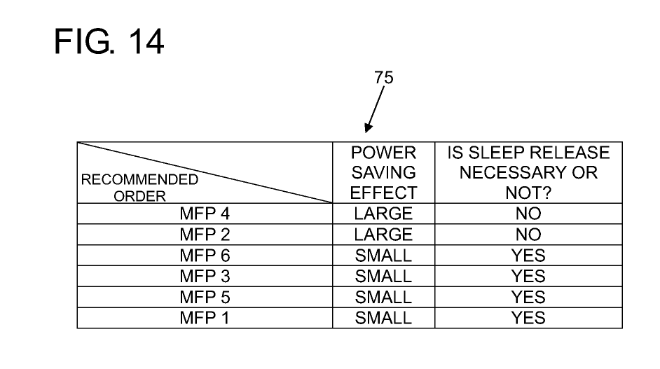

FIG. 14 shows an example of display in the case where the recommended MFP list formed by the second recommended MFP selection process of FIG. 13 is displayed on display device 41. Here, MFP 10 are listed in recommended order, and also, large or small effect of power saving in the case of executing the specified function by using the MFP 10 and whether the sleep release is required or not are displayed in correlation by each MFP 10. The MFP 10 determined to be usable of the specified function in step S142 is determined to be not-necessary of sleep release, and the other is determined to be necessary of sleep release.

Further, CPU 31 of information processing apparatus 30 may be configured to automatically determine the MFP 10 of the highest recommended order as the destination of job transmission, and automatically or after receiving user's consent, transmit the job to said MFP 10.

In this way, MFP system 5B relating to the second embodiment, in executing the specified function, recommends the MFP 10 unnecessary of sleep release as an execution apparatus of the job relating to the specified function, or automatically selects said MFP 10 and transmits the job to said MFP 10. Therefore, the user is enabled to select the suitable MFP for executing the job among the plurality of MFP 10 connected to the network from the view points of power saving effect, reducing the recovery time, and the like.

According to the second embodiment, since each MFP 10 determines the usable function by its own apparatus according to the power condition of the apparatus itself, processing burden to be shared by information processing apparatus 30 is reduced. In addition, by the time of power condition change, the usable function information is sent from MFP 10 to each of information processing apparatus 30, and the usable function table 80 in the information processing apparatus 30 is updated to the latest condition. Therefore at an occurrence of job, information processing apparatus 30 can rapidly select the recommended MFP by referring to the usable function table 80 stored in itself.

### Third Embodiment

In the first embodiment, when the power condition is changed, MFP 10 notifies the power condition after the change to each of information processing apparatus 30, while in the MFP system relating to the third embodiment, information processing apparatus 30 inquires of each MFP 10 about the power condition in the case of using the MFP 10 (in the case of job occurrence) to collect information. In other parts, the third embodiment is similar to the first embodiment, and the same parts will be arbitrarily omitted in explanation.

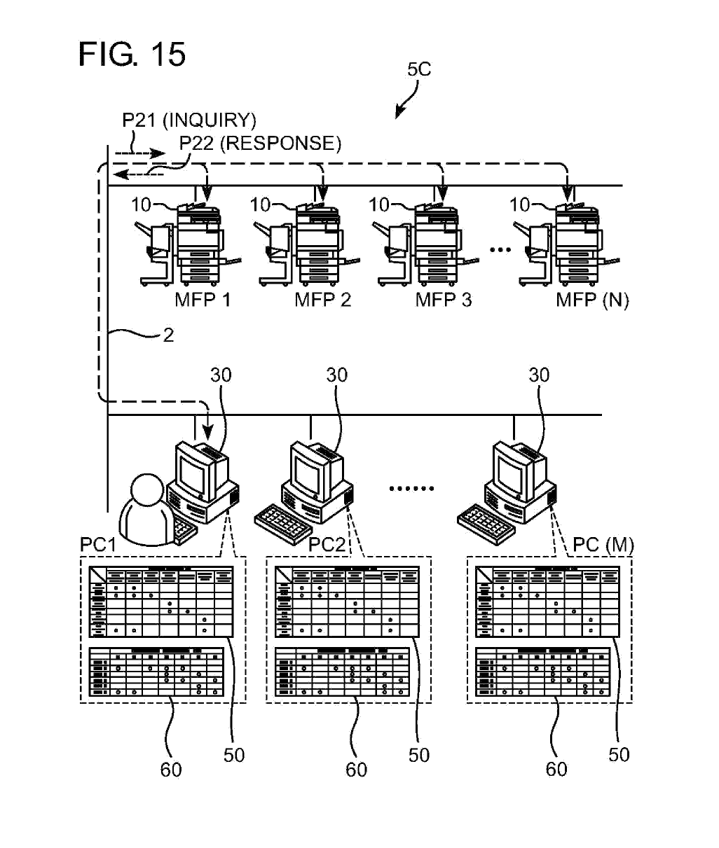

FIG. 15 shows a system configuration of MFP system 5C relating to the third embodiment. Each of information processing apparatus 30 stores the table of required units by each function 50 and the power condition table 60, similarly to the first embodiment.

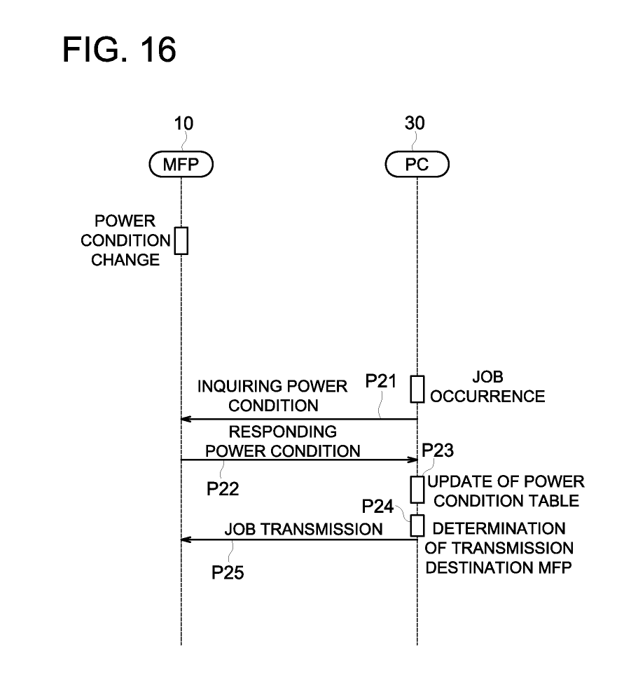

FIG. 16 is a drawing illustrating an MFP selection operation sequence in MFP system 5C of the third embodiment. MFP 10 stores power supply condition to each functional unit of its own apparatus when the MFP changed its own power condition at arbitrary time, for example in nonvolatile memory 14.

When receiving the specification of required function to be used from a user (job occurrence), the information processing apparatus 30 inquires of each MFP 10 about the power condition (P21), and in response to the inquiry, each MFP 10 transmits the power condition information indicating power condition of its own apparatus to the information processing apparatus 30 of inquiry source (P22).

Information processing apparatus 30 updates the power condition table 60 of its own apparatus based on the power condition information sent in response to the inquiry from each MFP 10 (P23). Then the information processing apparatus 30 determines the required functional unit for executing the specified function from the table of required units by each function 50, and selects the MFP 10 whose all required functional units are not in sleep mode, by referring to the power condition table 60 controlled by its own apparatus (P24), and transmits the job to the determined MFP 10 (P25).

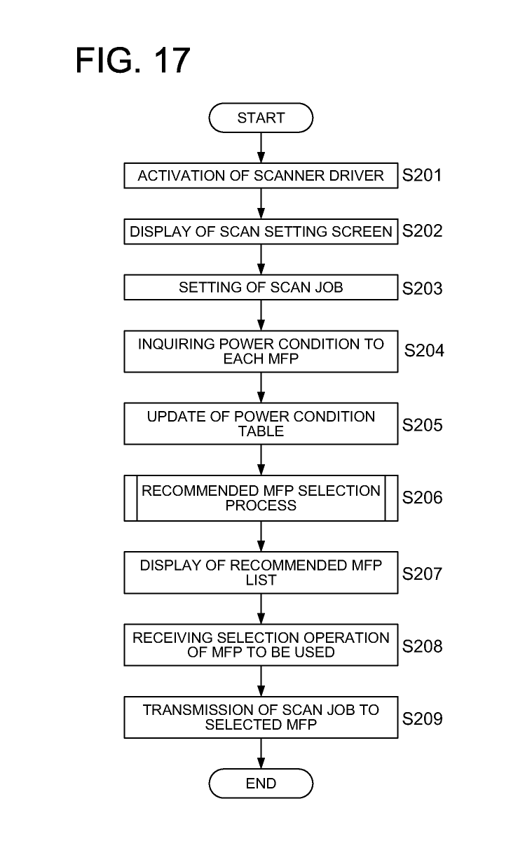

FIG. 17 is a flow diagram showing operations of the information processing apparatus 30 in the operation sequence of FIG. 16. This example shows the case of inputting a scanning job. When receiving an activation request of a scanner driver of MFP 10 from a program such as an image editing application, CPU 31 activates the corresponding scanner driver (step S201). CPU 31 for executing the scanner driver displays a scanner setting screen on display device 41 of information processing apparatus 30 in order to receive various settings regarding the scanning job (step S202). After completion of accepting the settings on the scanner setting screen, CPU 31 inquires of each MFP 10 about power conditions (step S204) and updates power condition table (step S205).

Then CPU 31 generates a recommended MFP list corresponding to the received job type (specified function) by executing the recommended MFP selection process same as that of FIG. 8 (step S206), and displays the generated recommended MFP list on display device 41 (step S207). The user determines MFP 10 by referring to the recommended MFP list. CPU 31 receives from the user a selection operation of MFP 10 for job transmitting destination (step S208), and transmits the scanning job having been set in step S203 toward the selected MFP 10 (step S209) to conclude the process.

In this way, according to MFP system 5C relating to the third embodiment, similarly to the case of the first embodiment, the user is enabled to select the suitable MFP for executing the job among the plurality of MFP 10 connected to the network from the view points of power saving effect, reducing the recovery time, and the like.

Further, since the MFP 10 inquires of each information processing apparatus 30 about the power condition at the time of job occurrence, communication volume is lessened and burden to network 2 is reduced, compared to the first embodiment where each MFP 10 notifies the power condition information at every time of power condition change. Further, in the first embodiment in order to receive the power condition information that is unknown of when being transmitted, the program for receiving the information is always kept in the side of information processing apparatus 30, which is not necessary in the third embodiment. Therefore, according to the third embodiment, processing burden to be shared by information processing apparatus 30 is reduced.

Furthermore, in the third embodiment, the information processing apparatus 30 may inquire of only the MFP having possibility of being used about power condition. For example by previously making only the MFP 10 register-able or register-changeable which is installed within a prescribed distance from said information processing apparatus 30, or which the user desires to use, the inquiry is done only of the corresponding MFP 10. Thus, the communication volume is further lessened. Further, cases where the MFP 10 undesired by the user is displayed in high recommended order, or automatically selected can be prevented.

### Fourth Embodiment

The MFP system relating to the second embodiment is configured such that in cases where MFP 10 has changed its own power condition, MFP 10 notifies a function usable by its own apparatus after changing the power condition to each information processing apparatus 30. While, in the MFP system relating to the fourth embodiment, information processing apparatus 30 inquires of each MFP 10 about usable function in the case of using the MFP 10 (in the case of job occurrence) to collect information. In other parts, the fourth embodiment is similar to the second embodiment, and the same parts will be arbitrarily omitted in explanation.

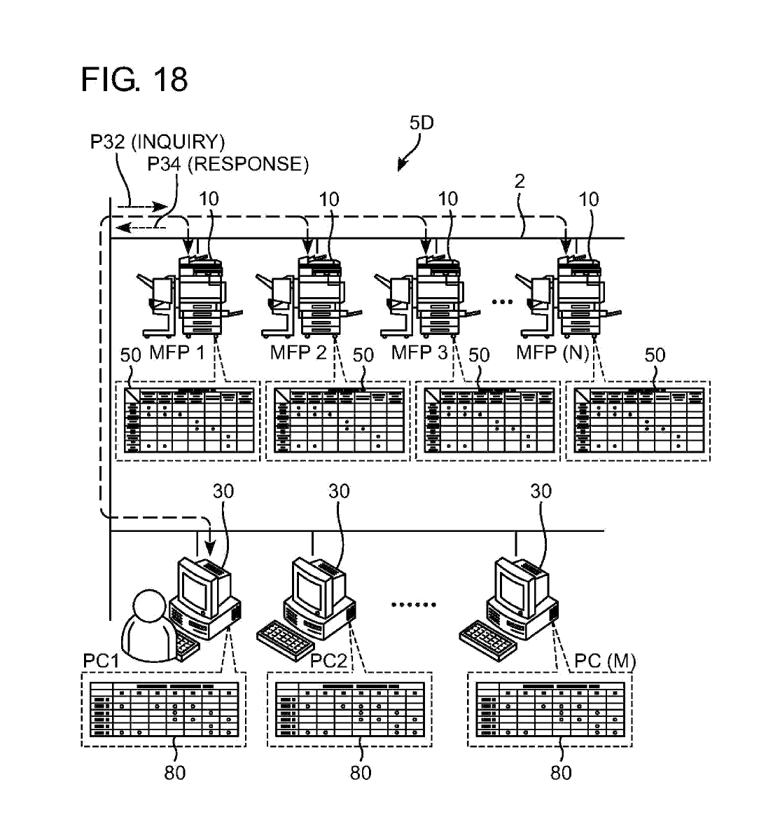

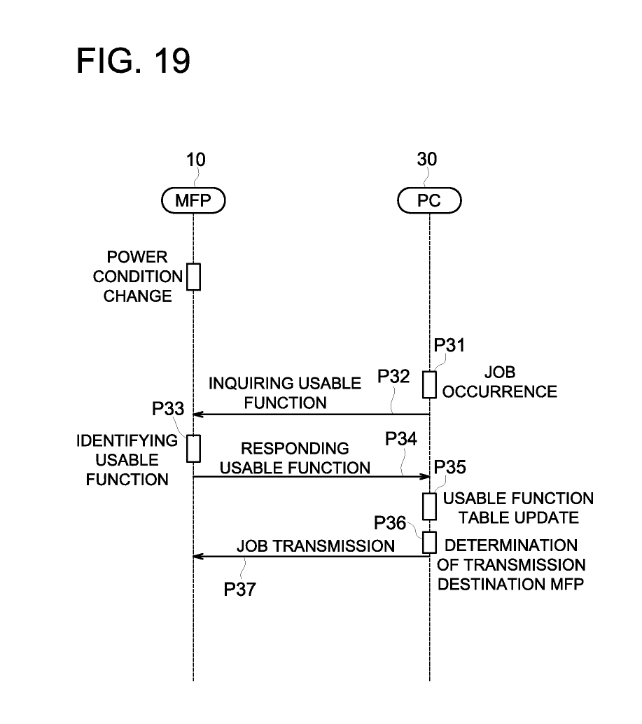

FIG. 18 shows a system configuration of MFP system 5D relating to the fourth embodiment. FIG. 19 illustrates an MFP selection operation sequence in MFP system 5D of the fourth embodiment. When changing the power condition of the own apparatus, each of MFP 10 stores the power condition after the change (power supply condition by each functional unit), for example in nonvolatile memory 14 of the own apparatus. When receiving a setting operation for the job to be executed by MFP 10 (P31), information processing apparatus 30 inquires of each MFP 10 about usable functions (P32).

The inquired MFP 10 determines the usable function by comparing the power condition of its own and the table of required units by each function 50 stored in its own apparatus (P33), and transmits the usable function information to the information processing apparatus 30 which inquired (P34).

Information processing apparatus 30 received of the usable function information updates the usable function table 80 stored in its own apparatus based on the content of received information (P35). Then, the information processing apparatus 30 determines a suitable MFP 10 for the destination of sending the job whose setting is previously received, based on the usable function table 80 stored in its own apparatus, and the type (function) of the job (P36). And, information processing apparatus 30 transmits the job to the determined MFP 10 (P37).

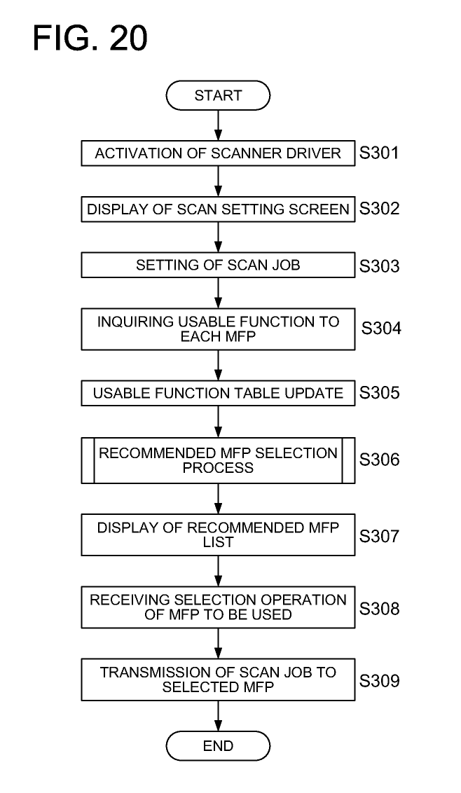

FIG. 20 is a flow diagram showing operations of the information processing apparatus 30 in the operation sequence of FIG. 19. This example shows the case of inputting the scanning job. When receiving an activation request of a scanner driver of MFP 10 from a program such as an image editing application, CPU 31 activates the corresponding scanner driver (step S301). CPU 31 for executing the scanner driver displays a scanner setting screen on display device 41 of information processing apparatus 30 in order to receive various settings regarding the scanning job (step S302). After completion of accepting the settings on the scanner setting screen (step S303), CPU 31 inquires of each MFP 10 about usable functions (step S304) and updates the usable function table (step S305).

Then CPU 31 generates a recommended MFP list corresponding to the received job type (specified function) by executing the recommended MFP selection process same as that of FIG. 13 (step S306), and displays the generated recommended MFP list on display device 41 (step S307). The user determines MFP 10 by referring to the recommended MFP list. CPU 31 receives a selection operation of MFP 10 for job transmitting destination (step S308), and transmits the scanning job having been set in step S303 toward the selected MFP 10 (step S309) to conclude the process.

In this way, according to MFP system 5D relating to the fourth embodiment, similarly to the case of the second embodiment, the user is enabled to select the suitable MFP for executing the job among the plurality of MFP 10 connected to the network from the view points of power saving effect, reducing the recovery time, and the like.

Further, since the MFP 10 inquires of each information processing apparatus 30 about the usable function at the time of job occurrence, communication volume is lessened and burden to network 2 is reduced, compared to the second embodiment where each MFP 10 notifies the usable function at every time of power condition change. Further, in the second embodiment in order to receive the power condition information that is unknown of when will be transmitted, the program for receiving the information is always kept in the side of information processing apparatus 30, which is not necessary in the fourth embodiment. Therefore, according to the fourth embodiment, processing burden to be shared by information processing apparatus 30 is reduced.

Furthermore, in the fourth embodiment, the information processing apparatus 30 may inquire of only the MFP having possibility of being used about the usable functions. For example by previously making only the MFP 10 register-able or register-changeable which is installed within a prescribed distance from said information processing apparatus 30, or which the user desires to use, the inquiry is done only of the corresponding MFP 10. Thus, the communication volume is further lessened. Further, cases where the MFP 10 undesired by the user is displayed in high recommended order, or automatically selected can be prevented.

### Fifth Embodiment

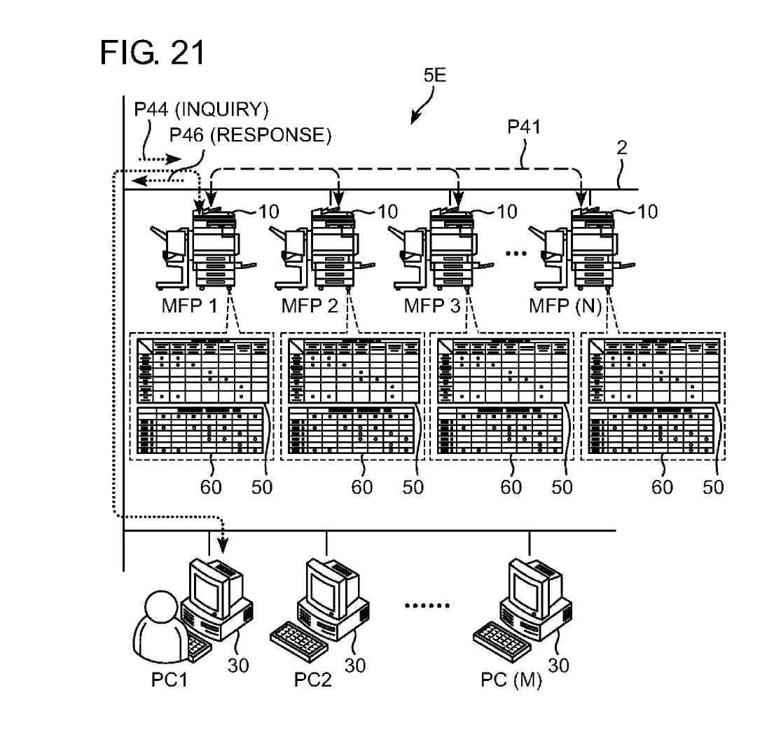

In the fifth embodiment, MFP 10 has all functions as the MFP selecting apparatus. As shown in FIG. 21, in the fifth embodiment, each MFP 10 exchanges and commonly keeps the power condition information with each other, and the MFP 10 is configured to determine and respond the recommended MFP 10 (P46) regarding the function inquired from information processing apparatus 30 (P44). In the fifth embodiment, each MFP 10 keeps the table of required units by each function 50 and the power condition table 60.

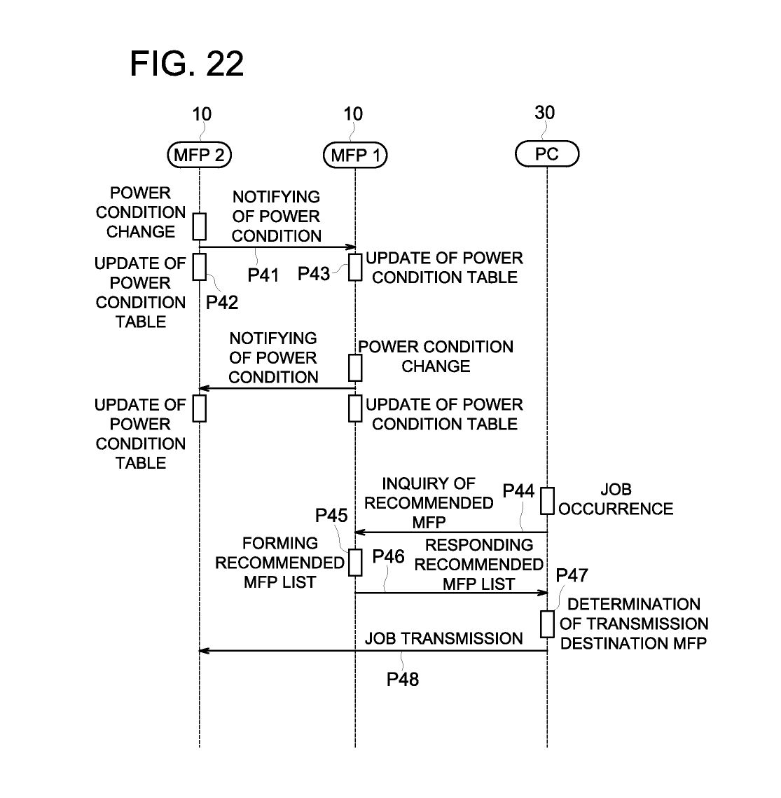

FIG. 22 shows an operation sequence for MFP selection in an MFP system 5E relating to the fifth embodiment. When arbitrarily changing the power condition of its own apparatus, each of MFP 10 notifies of the power condition after the change to every other MFP 10 (P41), and updates the power condition table 60 of its own apparatus (P42).

The MFP having received the notification updates its own power condition table 60 based on the notified content (P43).

When receiving a specification of the job desired from a user (job occurrence), the information processing apparatus 30 inquires of any one of MFP 10 about the recommended MFP with respect to the function (P44).

The MFP 10 having received of the inquiry refers to the table of required units by each function 50 and the power condition table 60 stored in its own apparatus, executes the same process as the recommended MFP selection process shown in FIG. 8 to generate a recommended MFP list (P45), and transmits the generated recommended MFP list to the information processing apparatus 30 having inquired (P46).

Information processing apparatus 30 receives and displays the recommended MFP list transmitted from the inquired MFP, and receives a determination operation of the MFP 10 by a user as the destination of sending the job (P47). Then, the information processing apparatus 30 transmits the job to the determined MFP 10 (P48).

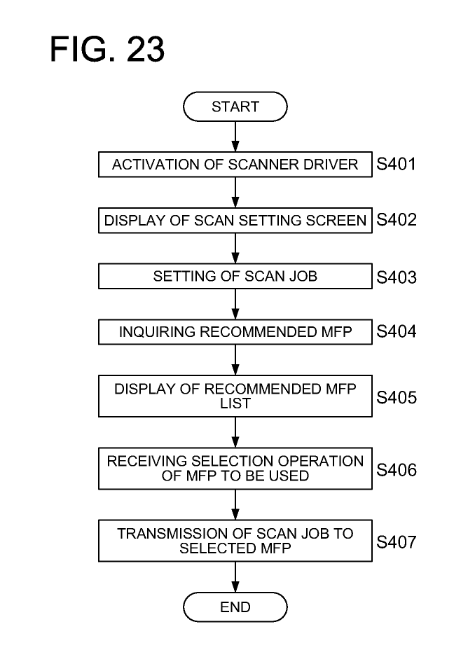

FIG. 23 is a flow diagram showing operations of the information processing apparatus 30 in the operation sequence of FIG. 22. This example shows a case of inputting a scanning job. When receiving an activation request of a scanner driver of MFP 10 from a program such as an image editing application, CPU 31 activates the corresponding scanner driver (step S401). CPU 31 for executing the scanner driver displays a scanner setting screen on display device 41 of information processing apparatus 30 in order to receive various settings regarding the scanning job (step S402). After completion of accepting the settings on the scanner setting screen (step S403), CPU 31 inquires of any one of MFP 10 about a suitable MFP 10 (recommended MFP) for the job (step S404), and receives recommended MFP list 71 as shown in FIG. 9 from the MFP 10 having been inquired. The MFP to be inquired of may be selected by a user at that time, or may be preliminary set.

Then, information processing apparatus 30 displays the received recommended MFP list on display device 41 (step S405). The user determines MFP 10 by referring to the recommended MFP list. CPU 31 receives a selection operation of MFP 10 for job transmitting destination (step S406), and transmits the scanning job having been set in step S403 toward the selected MFP 10 (step S407) to conclude the process.

In this way, according to MFP system 5E relating to the fifth embodiment, similarly to the case of the first embodiment, the user is enabled to select the suitable MFP for executing the job among the plurality of MFP 10 connected to the network from the view points of power saving effect, reducing the recovery time, and the like.

Further, since the recommended MFP list 71 is generated in the side of MFP 10, processing burden to be shared by information processing apparatus 30 is reduced. In addition, at every time of power condition change, each MFP 10 transmits the power condition information with each other, and the power condition table 60 of each MFP 10 is always updated to be the latest condition, therefore, in cases where MFP is inquired from the information processing apparatus, the MFP can quickly generates the recommended MFP list by referring to the power condition table 60 kept in its own apparatus and respond to the inquiry. Further, since the information processing apparatus 30 can quickly obtain the recommended MFP list by inquiring of MFP 10 only when necessary, processing burden to be shared by information processing apparatus 30 is small and a resident program is not necessary.

### Sixth Embodiment

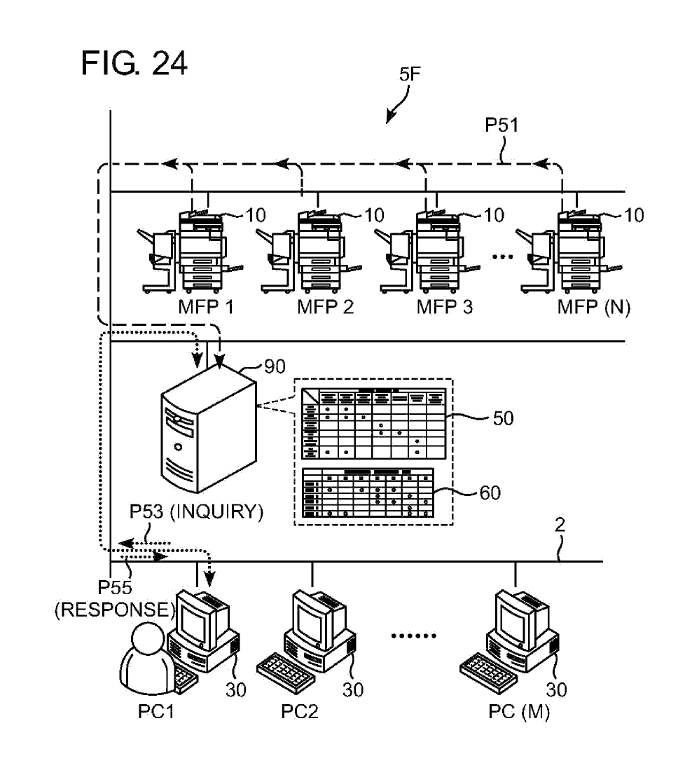

FIG. 24 shows a system configuration of MFP system 5F relating to the third embodiment. In the sixth embodiment, management server 90 provided with functions of an MFP selecting apparatus is connected with network 2. Management server 90 stores table of required units by each function 50 and power condition table 60.

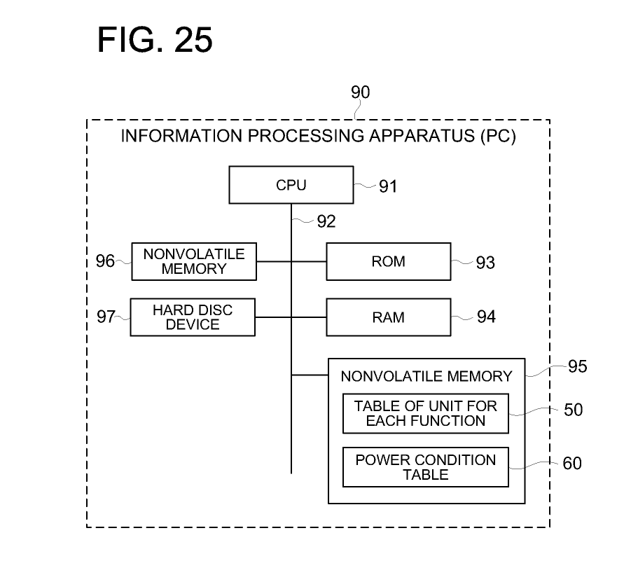

FIG. 25 shows an outline structure of management server 90. Management server 90 is configured of CPU 91 connected via bus 92 with ROM 93, RAM 94, nonvolatile memory 95, network I/F section 96 and hard disc device (HDD) 97. Other than these, a user I/F such as a liquid crystal display, a keyboard and a mouse may be provided.

In ROM 93, an activation program and fixed data are stored. RAM 94 memorizes a program loaded from hard disk device 37. Further, RAM 94 is utilized as a work memory to temporarily store various data in cases where CPU 91 executes a program.

Nonvolatile memory 95 is a memory whose stored content is not destroyed even in case of power off, and stores system information of said management server 90 (name, and IP address), user's information, various types of setting information, and names and IP addresses of managed MFP 10 and information processing apparatus 30, and in addition, stores table of required units by each function 50 and power condition table 60, and the like.

Network I/F section 96 performs a function of transmitting and receiving various data to and from an external apparatus such as MFP 10 and information processing apparatus 30 via network 2. Hard disc device 97 is a large capacity memory device, which stores an OS program, programs and data for realizing the functions of MFP selecting apparatus and the like.

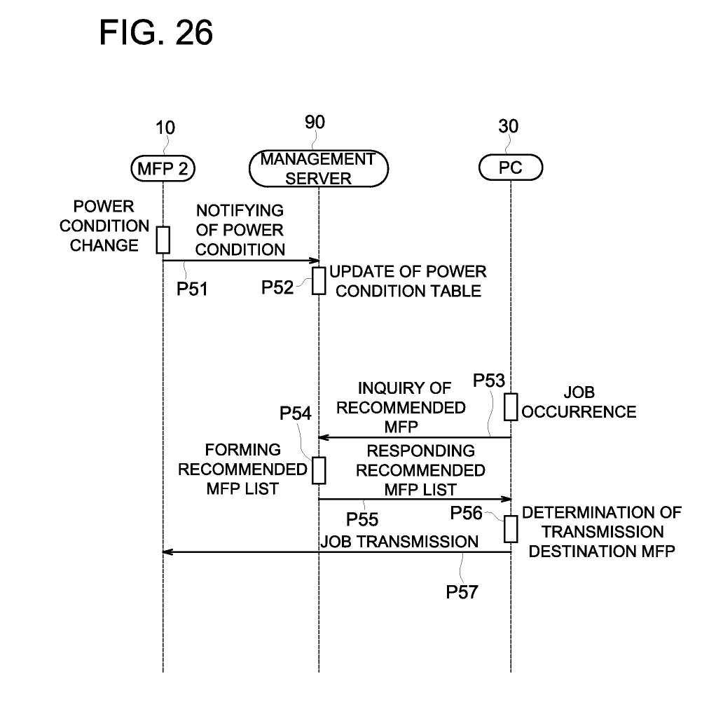

FIG. 26 is a drawing illustrating an MFP selection operation sequence in MFP system 5F of the sixth embodiment. When the MFP changed its own power condition at arbitrary time, MFP 10 notifies power condition after the change to management server 90 (P51). On receiving the notification, management server 90 updates power condition table 60 stored in its own apparatus based on the content of the notification.

When receiving the specification of desired function to be used from a user (job occurrence), the information processing apparatus 30 inquires of the management apparatus 90 about the recommended MFP for the desired function (P53).

The management server 90 having received of the inquiry refers to the table of required units by each function 50 and the power condition table 60 stored in its own apparatus, executes the same process as the recommended MFP selection process shown in FIG. 8 to generate a recommended MFP list (P54), and transmits the generated recommended MFP list to the information processing apparatus 30 having inquired (P55).

Information processing apparatus 30 receives and displays the recommended MFP list transmitted from the inquired MFP, and receives a determination operation of the MFP 10 as the destination of sending the job (P56). Then, the information processing apparatus 30 transmits the job to the determined MFP 10 (P57).

In this way, according to MFP system 5F relating to the sixth embodiment, similarly to the case of the first embodiment, the user is enabled to select the suitable MFP for executing the job among the plurality of MFP 10 connected to the network from the view points of power saving effect, reducing the recovery time, and the like.

Further, since the recommended MFP list 71 is generated in the management server 90, processing burdens to be shared by information processing apparatus 30 and MFP 10 are reduced. In addition, at every time of power condition change, each MFP 10 transmits the power condition information to management server 90, and the power condition table 60 of the management server 90 is always updated to be the latest condition, therefore, in cases where the management server 90 is inquired from the information processing apparatus 30, the management server 90 can quickly generate the recommended MFP list by referring to the power condition table 60 kept in its own apparatus and respond to the inquiry. Further, since the information processing apparatus 30 can quickly obtain the recommended MFP list by inquiring of management server 90 only when necessary, processing burden to be shared by information processing apparatus 30 is small and a resident program is not necessary.

### Seventh Embodiment

In the seventh embodiment, the operation of inquiring about recommended MFP 10 is received from the operation panel of MFP 10, and presentations of a recommended MFP list and recommended MFP 10 are displayed on the operation panel of MFP 10.

Here, an example will be shown where, similarly to the case of the fifth embodiment, each MFP 10 exchanges (P41) and commonly keeps the power condition information with each other. Types of jobs (functions) able to be inputted from the operation panel of MFP 10 are different from those in the case of receiving the jobs from information processing apparatus 30. Hence, each MFP 10 stores second table of required units by each function 55 to be used for receiving the jobs from the operation panel, and in cases of inquiry from the operation panel, refers the second table of required units by each function 55 in place of the table of required units by each function 50.

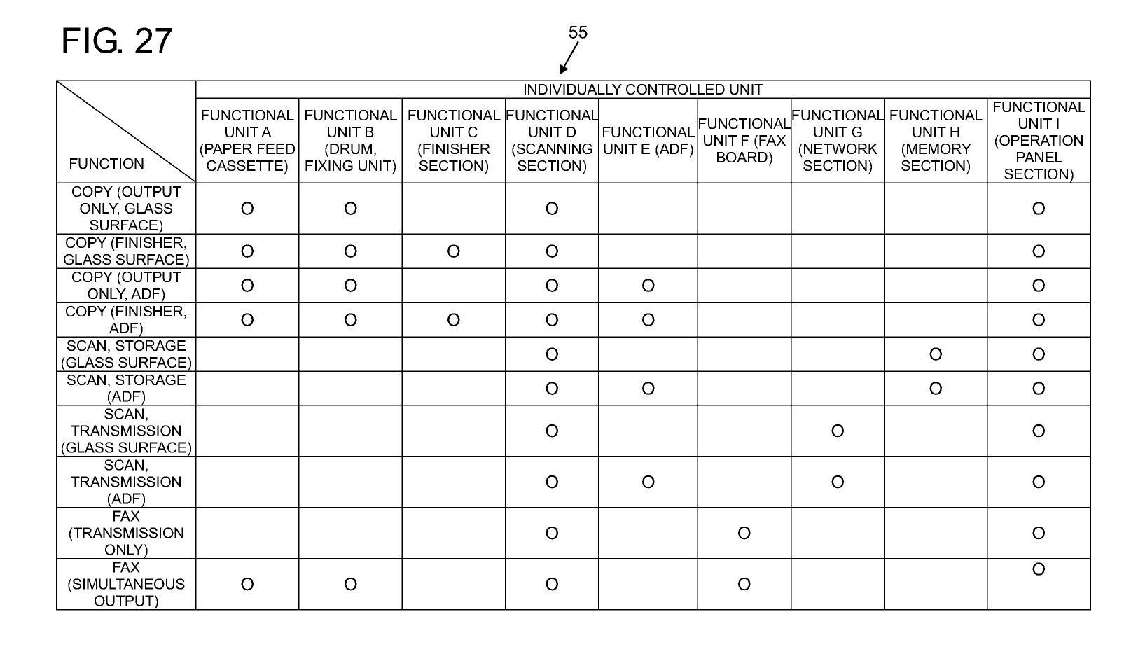

FIG. 27 is a drawing illustrating an example of the second table of required units by each function 55. Functions registered the second table of required units by each function 55 are relating to jobs capable of being inputted from the operation panel of MFP 10, the functions including copy (output only, grass surface), copy (finisher), copy (output only, ADF), copy (finisher, ADF), scan/storage (grass surface), scan/storage (ADF), scan/transmission (grass surface), scan/transmission (ADF), FAX (output only), and FAX (simultaneous output). In the second table of required units by each function 55, at a column of required functional unit for executing the function a circle mark (∘) is given.

Regarding the function of copy (output only, grass surface), functional units A, B, D, and I are used, and image forming section 12 executes the print based on the image data read out from an original document placed on a platen grass. In the function of copy (finisher, grass surface), image forming section 12 executes the print based on the image data read out from an original document placed on a platen grass, and further, post-processing such as punching, stapling, and folding are executed on the printed material.

In the function of copy (output only, ADF), functional units A, B, D, E, and I are used to execute sequential reading of one or plural sheets of original document conveyed by an Automatic Document Feeder, and printing the read image data by image forming section 12. In the function of copy (finisher, ADF), functional units E is used in addition to the case of the function of copy (finisher, grass surface), to execute sequential reading of one or plural sheets of original document conveyed by an Automatic Document Feeder, printing the read image data by image forming section 12, and further, post processing such as punching, stapling, and folding are executed on the printed material.

In the function of scan/storage (grass surface), functional units D, H, and I are used to execute reading of the original document placed on the platen grass, and storing the read image data in functional unit H (HDD, etc.). In the function of scan/storage (ADF), functional units D, E, H, and I are used to execute sequential reading of one or plural sheets of original document conveyed by an Automatic Document Feeder, and storing the read image data in functional unit H (HDD, etc.).

In the function of scan/transmission (grass surface), functional units D, G, and I are used to execute reading of the original document placed on the platen grass, and transmitting the read image data via network 2 to an external terminal. In the function of scan/transmission (ADF), functional units D, E, G, and I are used to execute reading of one or plural sheets of original document conveyed by an Automatic Document Feeder, and transmitting the read image data via network 2 to an external terminal.

In the function of FAX (transmission only), functional units D, F, and I are used to execute reading of the original document placed on the platen grass, and facsimile transmitting the read image data to a designated destination. In the function of FAX (simultaneous output), functional units A, B, D, F, and I are used to execute reading of one or plural sheets of original document conveyed by an Automatic Document Feeder, and print-outputting by image forming section 12, in addition to facsimile transmitting the read image data to a designated destination.

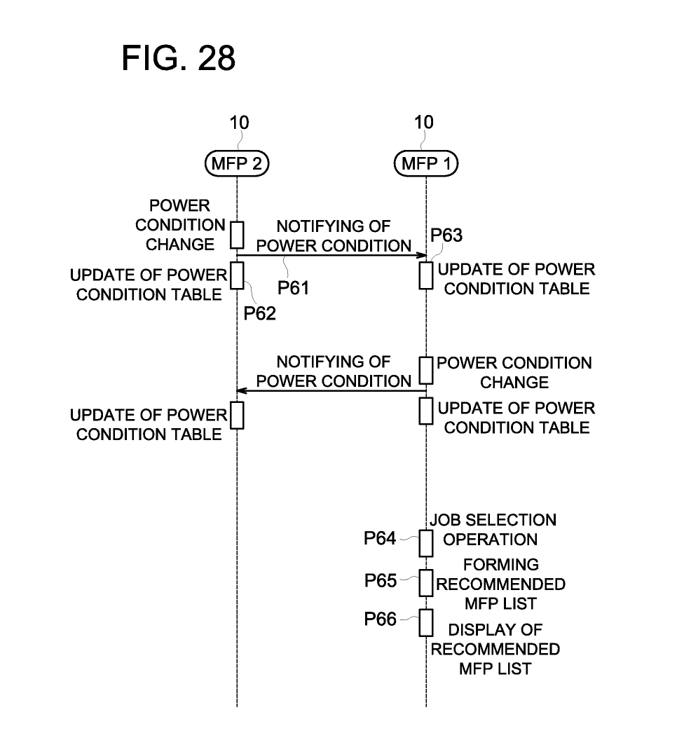

FIG. 28 is a drawing illustrating an operation sequence of MFP 10 of the seventh embodiment. In cases where a power condition of own apparatus is changed at arbitrary time, MFP 10 transmits the power condition after the change to every other MFP 10 (P61), and updates the power condition table 60 of its own apparatus (P62).

MFP 10 received of the power condition information updates power condition table 60 stored in its own apparatus based on the content of the received information (P63).

MFP 10 receives a setting operation for a job to be executed via an operation panel (functional unit I) of its own apparatus (P64). For example, by displaying an inquiry screen (not illustrated) provided with selection buttons respectively corresponding to each functions shown in FIG. 27, receives a specification of a function via an operation of any of the selection buttons.

Controller 11 of MFP 10 refers to the second table of required units by each function 55 and the power condition table 60 stored in its own apparatus, executes the same process as the recommended MFP selection process shown in FIG. 8 to generate a recommended MFP list (P65), and displays the generated recommended MFP list (P66).

By viewing the recommended MFP list displayed on the operation panel, a user determines MFP 10 and moves to the determined MFP 10 and input the job (in case the determined MFP being said MFP, input the job to said MFP).

Here a configuration is shown as an example where each MFP 10 exchange the power condition information with each other, the configuration as that of the sixth embodiment where management server 90 is provided may be applicable. In this case, each MFP 10 receives a specifying operation of a function from its operation panel, inquires of management server 90 about the recommended MFP corresponding to the specified function, and displays the recommended MFP list received as a response from management server 90 on its operation panel.

In this way, according to the seventh embodiment, similarly to the case of the first embodiment, with respect to a job which is capable of being inputted through an operation panel of MFP, the user is enabled to select the suitable MFP for executing the job among the plurality of MFP 10 connected to the network from the view points of power saving effect, reducing the recovery time, and the like.

### Eighth Embodiment

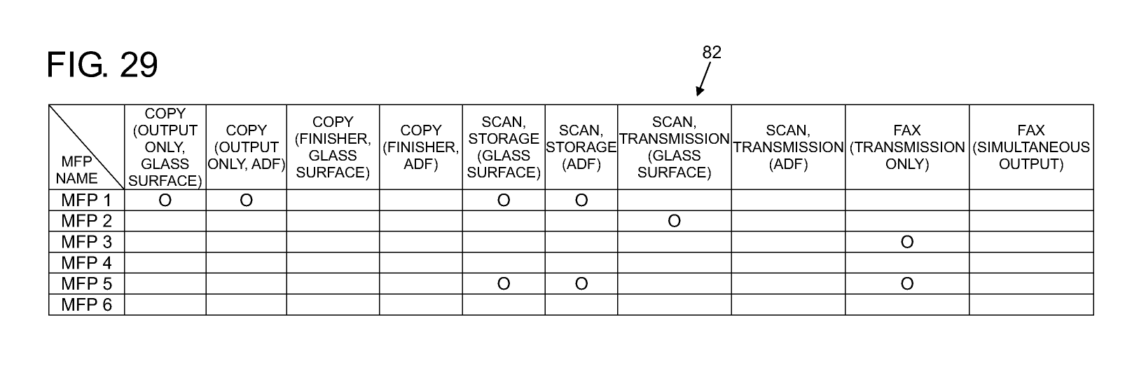

In the eighth embodiment, a recommended MFP corresponding to the function designated by a user via an operation panel is selected, and the recommended MFP corresponding to the designated function is displayed. While in the eighth embodiment, without particularly receiving the designation of function, MFP 10 displays on the operation panel a list of usable functions respectively by its own apparatus and the other MFP 10 connected to network 2. For example in a waiting screen, usable function table 82 indicating usable functions by each MFP 10 as shown in FIG. 29 is displayed.

Each MFP 10 stores the second table of required units by each function 55, power condition table 60 and usable function table 82.

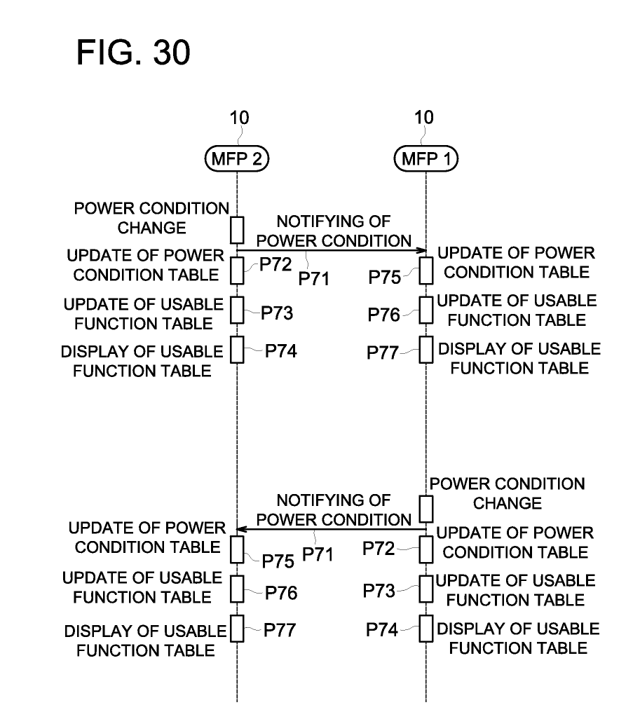

FIG. 30 is a drawing illustrating an operation sequence of MFP 10 of the eighth embodiment. In cases where a power condition of own apparatus is changed at arbitrary time, MFP 10 notifies the power condition after the change to every other MFP 10 (P71). Then updates the power condition table 60 of its own apparatus (P72), determines a usable function by comparing the updated power condition table 60 with the second table of required units by each function 55, and updates the usable function table 82 (P73) and displays it on the operation panel (P74).

MFP 10 received of the power condition information updates power condition table 60 stored in its own apparatus based on the content of the received information (P75). Further, determines a usable function by comparing the updated power condition table 60 with the second table of required units by each function 55, and updates the usable function table (P76) and displays it on the operation panel (P77).

The user determines MFP 10 executable of user's desired job (function) by viewing the usable function table 82 displayed on the waiting screen of MFP 10, and moves to the determined MFP 10 to input the job.

Here a configuration is shown as an example where each MFP 10 exchange the power condition information with each other, the configuration as that of the sixth embodiment where management server 90 is provided may be applicable. In this case, each MFP 10 acquires a usable function table from management server 90 and displays it on the operation panel. Management server 90 stores and updates the second table of usable units by each function 55, power condition table 60 and usable function table 82.

For example, by each time of receiving the power condition information from MFP 10, management server 90 updates power condition table 60 and further updates the usable function table. And when receiving a request of acquiring the usable function table from MFP 10, management server 90 transmits, in response to the request, the usable function table stored in its own apparatus toward said MFP 10.

Alternatively, a configuration may be possible where by each time of receiving the power condition information from MFP 10, management server 90 updates the power condition table 60, and management server 90 generates the usable function table when receiving the request of acquiring the usable function table from MFP 10, and transmits to said MFP 10.

In this way, according to the eighth embodiment, with respect to a job which is capable of being inputted through an operation panel of MFP, the user is enabled to select the suitable MFP for executing the job among the plurality of MFP 10 connected to the network from the view points of power saving effect, reducing the recovery time, and the like.

### Ninth Embodiment

In the ninth embodiment, with respect to a functional unit out of running condition (a functional unit in sleep condition), a power recovery factor indicating a load amount for making the functional unit recover to running condition is established. In cases where two or more MFP 10 requiring a sleep release for executing a specified function are present, by calculating a sum total of the recovery factors of functional units required of sleep release by each of said MFP 10, recommended orders are determined based on the amount of the sum total.

The recovery factor is a parameter being established according to required power consumption or start-up time. For example, in a case where power supply conditions to a functional unit are only ON and OFF, the value of power recovery factor is setup based on the difference of power consumption amount between ON and OFF. In cases where a single functional unit has multiple sleep conditions of different power consumption, the value of present power recovery factor of the functional unit is determined based on the difference of power consumption between the present sleep condition and the running condition. Further, the value of power recovery factor is determined based on the required time period (start-up time) for transition from the present condition to the running condition.

In this way, the power recovery factor differs in value by each functional unit, and further according to the present condition of the functional unit. For example, MFP 10 previously memorizes a power recovery factor table indicating the power recovery factors by each functional unit, or in cases where the sleep conditions exist in multiple levels, indicating the power recovery factors by each functional unit and by each levels, and by referring to the power recovery factor table derives the present power recovery factors of each functional unit.

As the power condition information, in addition to the information indicating whether each functional unit is in running condition or not, MFP 10 notifies the power recovery factor based on the present condition of the functional unit.

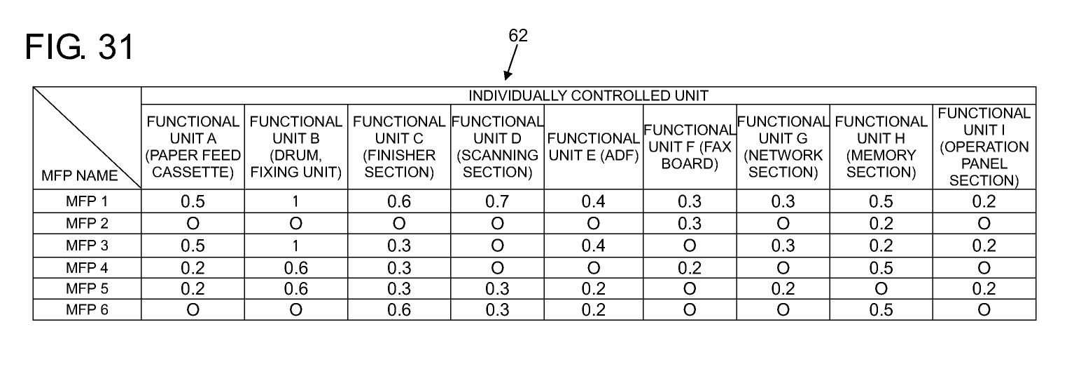

FIG. 31 shows an example of power condition table 62 provided with power recovery factors. In power condition table with power recovery factors 62, with respect to the functional unit out of running condition, its power recovery factor is registered. Here, the power recovery factor α takes a value in the range of 1>a>0, and the nearer the value goes to 0, the load for recovery to the running condition becomes smaller.

Hereinafter, an example of the case where power condition table with power recovery factors 62 is utilized in place of power condition table 60 will be described.

The operation sequence is approximately same as the case of FIG. 28, but different in following points. In cases where a power condition of own apparatus is changed at arbitrary time, MFP 10 acquires the power recovery factor of the functional unit whose condition after the change is not in running condition, and notifies the running condition of each functional unit and the power condition information including the power recovery factor of the functional unit out of running condition to every other MFP 10 (P61). Then, the MFP 10 updates the power condition table with power recovery factors 62 of its own apparatus (P62). Namely regarding the functional unit out of running condition, its power recovery factor is registered at the corresponding part of the power condition table with power recovery factors 62.

MFP 10 having received the notification updates the power condition table with power recovery factors 62 stored in its own apparatus based on the content of the received notification (P63). Namely in the case of being notified of the power recovery factor, its power recovery factor is registered at the corresponding part of the power condition table with power recovery factors 62.

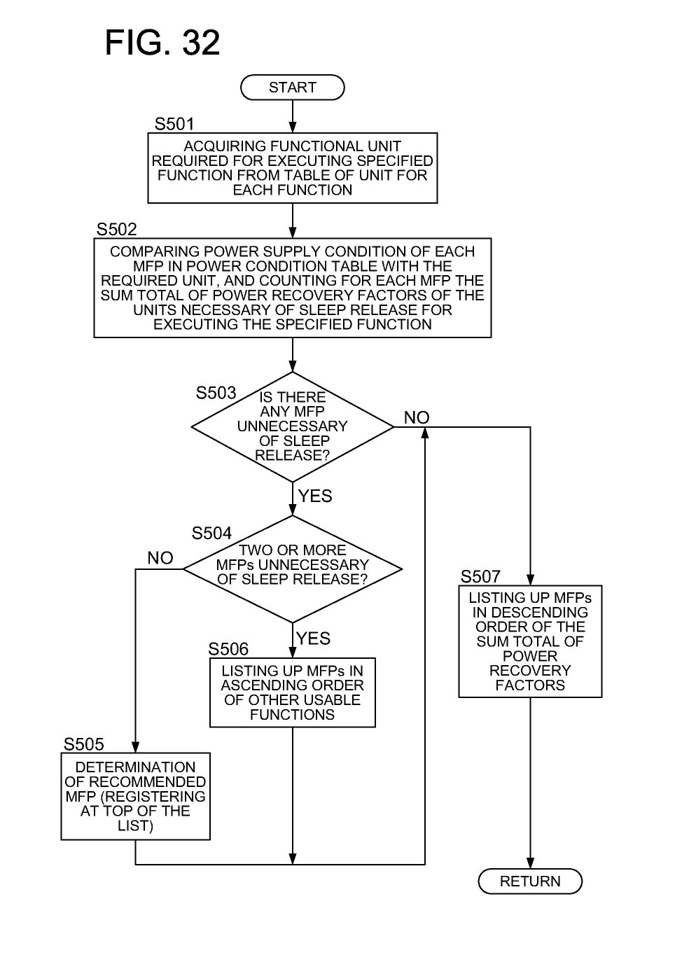

In the case of generating the recommended MFP list (P65) MFP 10 executes the third recommended MFP selection process shown in FIG. 32, in place of the recommended MFP selection process shown in FIG. 8.

In the third recommended MFP selection process shown in FIG. 32, MFP 10 refers to the second table of required units by each function 55 (FIG. 27) and the power condition table with power recovery factors 62 (FIG. 31) stored in its own apparatus. Specifically, acquires the required functional unit for executing the specified function from the second table of required units by each function 55 (step S501). Subsequently, by comparing to the power condition of functional unit in each MFP 10 registered in the power condition table with power recovery factors 62, extracts the MFP 10 having the functional unit necessary of sleep release for executing the specified function, and with respect to the extracted MFP, acquires the sum total of the power recovery factors of each functional units necessary of sleep release (step S502).

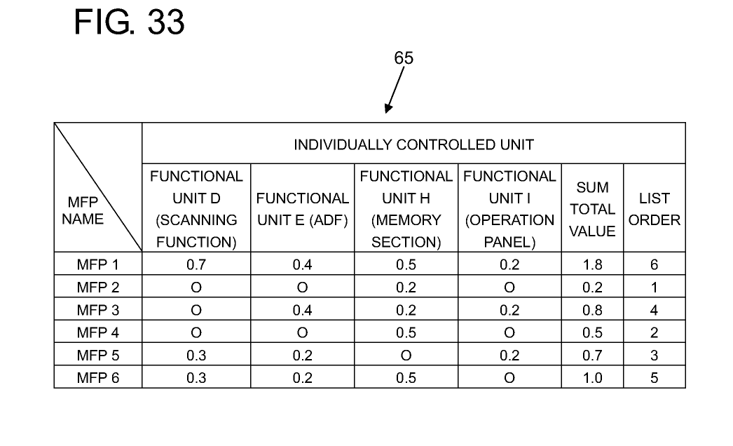

For example, in the case where the specified function is “scan/storage (ADF)”, from the second table of required units by each function 55 of FIG. 27, functional units D, E, H, and I are found to be necessary of power supply. And, in case that the power condition table with power recovery factors 62 is in the condition shown in FIG. 31, every MFP 10 is necessary of sleep release, and the sum total of the power recovery factors by each MFP 10 becomes the value shown in sum total value of power recovery factors list 65 shown in FIG. 33. The listed order in the sum total value of power recovery factors list 65 shows the order of less sum total value.

Subsequently, CPU 31 judges whether the MFP 10 unnecessary of sleep release (no functional unit necessary of sleep release) is present or not (step S503). In the case where MFP 10 unnecessary of sleep release is present (step S503; Yes) and the number of said MFP is one (step S504; No), determines the MFP 10 unnecessary of sleep release as the most recommended MFP, registers at the top of the recommended MFP list (step S505), and moves to step S507.

In the case where two or more MFP 10 unnecessary of sleep release are present (step S504; Yes), CPU 31 registers said MFP 10 in ascending order of other usable functions (step S506), and moves to step S507.

After registering the MFP 10 unnecessary of sleep release in steps S505 and S506, or in the case where the MFP 10 unnecessary of sleep release is not present (step S503; No), CPU 31 registers MFP 10 necessary of sleep release in ascending order of the sum total of power recovery factors (in cases where already registered MFP is present, additionally registers subsequently) (step S507), and concludes the process (Return).

For example, in the above described case, each MFP 10 is registered in the recommended MFP list with the order shown in the list order of sum total value of power recovery factors list 65, namely with the order of: MFP2, MFP4, MFP5, MFP3, MFP6, and MFP1.

In this way, by establishing a power recovery factor indicating a load amount for making the functional unit out of running condition recover to running condition, the recommended order of MFP 10 necessary of sleep release is determined based on the sum total value of the power recovery factors of each MFP 10, therefore, more appropriate decision of the recommended order can be achieved compared to the case of determining only by necessity of sleep release.

In cases where the power recovery factor indicates the startup time, the recommended order is preferably decided based on the maximum value (the power recovery factor corresponding to the maximum startup time) among the functional unit necessary of sleep release, not based on the sum total value of power recovery factors. This is because recoveries from sleep condition are simultaneously conducted with respect to a plurality of functional units. Further, in cases where the power recovery factor is defined by concurrently utilizing the power consumption and startup time, the power recovery factors are preferably controlled by separating to first power recovery factors corresponding to power consumption and the like and second power recovery factors corresponding to startup time, and the recommended order is preferably determined based on the value obtained by adding or multiplying the second power recovery factors to the first power recovery factors.

### Tenth Embodiment

In the tenth embodiment, the recommended order is determined by further taking into consideration of separately established items from that relating to the power consumption. For example the recommended order is determined by considering such items as: a distance or a location (such as located on the same floor) of MFP 10 from the information processing apparatus 30 used by a user; usage history by the user (for example, a certain user frequently uses MFP1, and the like); total usage history (for example, MFP2 is totally used in large number of times); priority order preliminary set by the user (user factor), and the like.

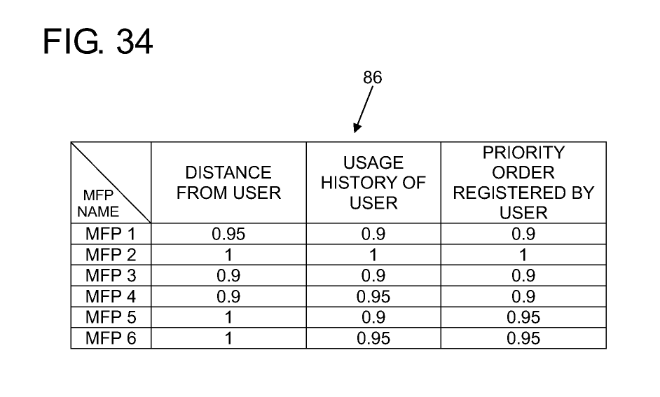

For example, as the separately established item from that relating to the power consumption, the user factor is established. FIG. 34 shows an example of user factor table 86 in which each user factor is listed by each MFP 10. In case of considering the user factor with respect to plural items, the value obtained by multiplying user factors of each items is assumed to be a total user factor. For example, user factor β is defined to take values in the range of:

1>β>0, and assumed that the nearer to 0, the more preferable for the user (recommended order becoming higher). Further, in cases of considering both the power recovery factor and the user factor, by assuming the value obtained by multiplying the user factor to the power recovery factor as a priority factor, the recommended order may be determined based on the priority factor.

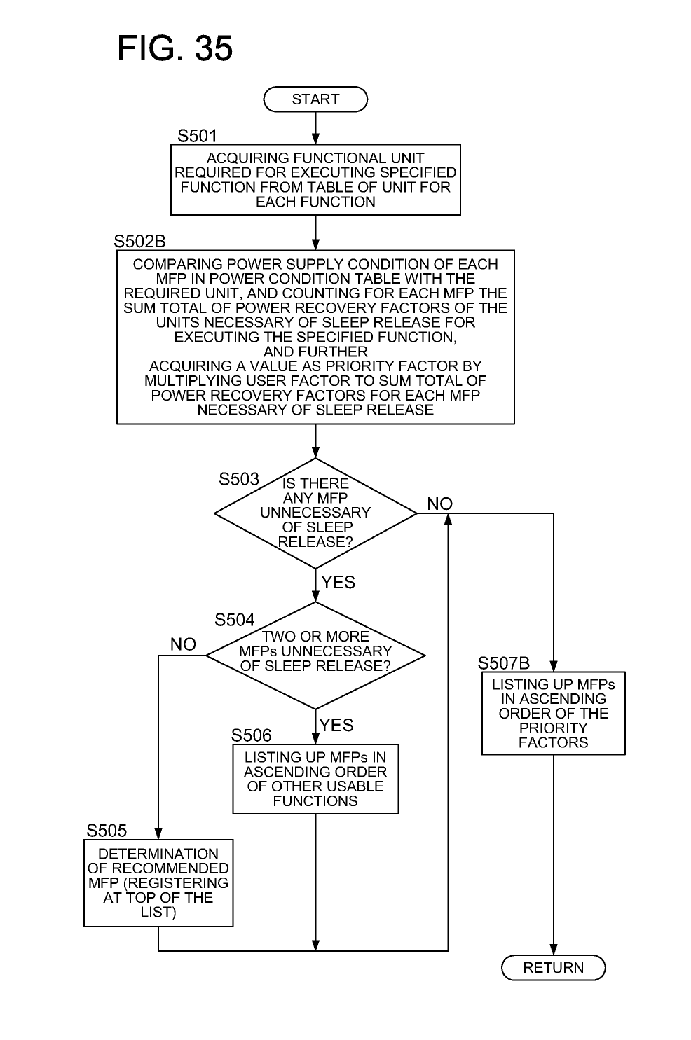

In cases of utilizing the priority factor, the MFP recommendation process shown in FIG. 35 is executed in place of the process of FIG. 32. In FIG. 35, process of same content as FIG. 32 is given with the same step number. Differences are to execute the step S502B of FIG. 35 in place of step 502 of FIG. 32, and to execute the step S507B of FIG. 35 in place of step 507 of FIG. 32.

Specifically, in step S502B, by comparing the power supply condition of each MFP 10 in the power condition table with the required functional unit, the sum total of power recovery factors of the unit necessary of sleep release for executing the specified function is obtained by each MFP 10, And further, a value obtained by multiplying the user factor to the sum total of power recovery factors is obtained as the priority factor by each MFP 10. Further, in step S507B, each MFP 10 is listed up in ascending order of the priority factors.

In the case where two or more MFP 10 unnecessary of sleep release are present, MFP 10 may be listed up in step S506 in an order based on the user factors (in case of plural user factors, based on the value obtained by multiplying them). Namely, the order may be determined by use of the user factor in place of the number of other functions, or based on the value obtained by multiplying the user factor to the number of other functions, or based on the user factor in only the case where the number of other functions is same. Further in cases where the order is determined based on only the user factor without considering the power recovery factor, MFP 10 may be listed up in ascending order of the user factors, in step S507B.

With respect to the user factor, values of items such as distance/location, and a priority order registered by a user are previously set and registered by each user (a user factor table is provided for each user) to be used. The user factor relating to the usage history is acquired by the apparatus with a prescribed calculation from the actual usage history. The identification of the user is executed in a user authentication at the time of login to MFP 10 or information processing apparatus 30.

In this way, by taking the user factor into consideration, the recommended order is determined by further considering the items separately set from the items relating to the power saving, thus the power saving effect and recovery time reducing effect can be attained with respecting the user's convenience.

Although embodiments of the present invention are explained by reference of the drawings in the above description, specific configuration is not restricted to that shown in embodiments, and changes and modifications may be made without departing from the spirit or scope of the invention.

For example, either of MFP 10, information processing apparatus 30 and management server 90 may determine the MFP 10 to be used depending on the system configuration.

Required units by each function table 50 and the second required units by each function table 55 shown in the embodiments are only examples, and the required unit table should not be restricted to either of these tables. MFP 10 may keep both the required units by each function table 50 and the second required units by each function table 55, and may switch the table according to the site where the job is inputted form the information processing apparatus 30 or from the operation panel of MFP 10.

Further, required units by each function table 50 and the second required units by each function table 55 shown in the embodiments indicate the functional units necessary for executing the function by each function. Alternately, the usable function by the combination of the running conditions may be correlated with the combination of running functional units, and displayed.

In the embodiments, with respect to the power recovery factor and the user factor, the case where the function is specified from the operation panel of MFP 10 is exemplified, however, the other configuration, for example, where the job is inputted from information processing apparatus 30 may be similarly applicable.

Further, in cases where recommendation order of the job, which being capable of inputted from the operation panel, is determined by using the second required units by each function table 55, the result of determination (recommended MFP list, and the like) may not be displayed (or notified) at the operation panel of MFP 10, but may be displayed on display device 41 of information processing apparatus 30, on management server 90 and the like, and further on arbitral apparatus on the network.

In the embodiments, the whole recommended MFP list 71 is displayed to notify the user, however, only several MFP in higher order may be displayed. Further, the number of MFPs to be displayed in high priority may be arbitrarily set. For example, only three high priority apparatuses of MFP 10 may be displayed, only the MFP 10 unnecessary of sleep release may be listed up, or the MFP 10 of highest priority may be notified. Further, items other than the power saving element, such as items of the location and the process speed of each MFP 10 are preferably displayed, as supplemental information for selection of MFP 10.

What is claimed is:

1. A multifunction peripheral selecting apparatus for selecting a multifunction peripheral which is capable of controlling a power supply condition to a plurality of units and executing a plurality of functions each requiring different units, the multifunction selecting apparatus comprising:
an acquisition section which acquires the power supply condition by each of the plurality of units of the multifunction peripheral;
a memory section which previously stores required unit information indicating a correspondence relation between a function and units required for executing the function;
an input section which receives a designation of the function;
a selection section which selects a suitable multifunction peripheral for executing the designated function from a plurality of the multifunction peripherals, which are subjects to be controlled, based on an acquisition result by the acquisition section and the required unit information stored in the memory section; and
a notification section which notifies a user of the selected suitable multifunction peripheral.

2. The multifunction peripheral selecting apparatus of claim 1, wherein the selection section selects, as the suitable multifunction peripheral, a multifunction peripheral in which every unit required for executing the designated function is supplied with electric power.

3. The multifunction peripheral selecting apparatus of claim 2, wherein the notification section executes the notification by presenting to a user with a list of the plurality of multifunction peripherals, the list including information of whether each of the multifunctional peripheral is supplied with the electric power to every unit required for executing the designated function.

4. The multifunction peripheral selecting apparatus of claim 2, wherein in cases where plural multifunction peripherals which are supplied with the electric power to every unit required for executing the designated function are available, the notification section notifies the user of the plural multifunction peripherals with the less priority order of a multifunction peripheral which has the more functions for which the electric power is supplied to every required unit.

5. The multifunction peripheral selecting apparatus of claim 1, wherein in cases where plural multifunction peripherals which are not supplied with the electric power to any unit required for executing the designated function are available, the notification section notifies the user of the plural multifunction peripherals with the less priority order of a multifunction peripheral which has the more required units which are not supplied with the electric power.

6. The multifunction peripheral selecting apparatus of claim 1, wherein in cases where plural multifunction peripherals which are not supplied with the electric power to any unit required for executing the designated function are available, the multifunction peripheral selecting apparatus gives a weighting factor to each of the required unit, obtains sum total of the weighting factor by each of the plural multifunction peripherals, and executes the notification with a priority order based on the sum total of the weighting factor.

7. The multifunction peripheral selecting apparatus of claim 1, wherein a terminal apparatus, connected via a network to the multifunction peripheral selecting apparatus, receives the designation; and the notification is executed on a display screen of the terminal apparatus having received the specification.

8. A multifunction peripheral selecting apparatus for selecting a multifunction peripheral which is capable of controlling a power supply condition to a plurality of units and executing a plurality of functions each requiring different units, the multifunction selecting apparatus comprising:
an acquisition section which acquires the power supply condition by each of the plurality of units of the multifunction peripheral;
a memory section which previously stores required unit information indicating a correspondence relation between a function and units required for executing the function;
an input section which receives a designation of the function; and
an automatic selection section which selects a suitable multifunction peripheral for executing the designated function from a plurality of the multifunction peripherals, which are subjects to be controlled, based on an acquisition result by the acquisition section and the required unit information stored in the memory section, and determines the selected multifunction peripheral as an executing destination of a job corresponding to the designated function.

9. The multifunction peripheral selecting apparatus of claim 8, wherein the automatic selection section selects, as the suitable multifunction peripheral, a multifunction peripheral in which every unit required for executing the designated function is supplied with electric power.

10. The multifunction peripheral selecting apparatus of claim 8, wherein a terminal apparatus, connected via a network to the multifunction peripheral selecting apparatus, receives the designation and an input operation of the job corresponding to the designated function; and the automatic selection section transmits the job to the multifunction peripheral determined as the executing destination of the job.

11. A multifunction peripheral selecting apparatus for selecting a multifunction peripheral which is capable of controlling a power supply condition to a plurality of units and executing a plurality of functions each requiring different units, the multifunction selecting apparatus comprising:
an acquisition section which acquires the power supply condition by each of the plurality of units of the multifunction peripheral;
a memory section which previously stores required unit information indicating a correspondence relation between a function and units required for executing the function;
an input section which receives a designation of the function;
a notification section which notifies a user of the selected suitable multifunction peripheral;
a selection section which selects a suitable multifunction peripheral, from a plurality of the multifunction peripheral, for executing each of the plurality of functions, based on an acquisition result by the acquisition section and the required unit information stored in the memory section; and
a notification section which notifies the user of each of the plurality of functions, and the selected multifunction peripheral by correlating to each of the plurality of functions.

12. The multifunction peripheral selecting apparatus of claim 11, wherein the selection section selects, as the suitable multifunction peripheral for executing each of the plurality of functions, a multifunction peripheral in which every unit required for executing the designated function is supplied with electric power.

13. The multifunction peripheral selecting apparatus of claim 11, wherein the notification section notifies on a display section of the multifunction peripheral.

14. A multifunction peripheral selecting method for selecting a multifunction peripheral which is capable of controlling a power supply condition to a plurality of units and executing a plurality of functions each requiring different units, the multifunction peripheral selecting method comprising the steps of:
acquiring a power supply condition by each of the plurality of units of the multifunction peripheral;
receiving a designation of a function from a user;
selecting a suitable multifunction peripheral for executing the designated function from a plurality of the multifunction peripherals, which are subjects to be controlled, based on an acquisition result and previously stored required unit information indicating a correspondence relation between the function and units required for executing the function; and
notifying a user of the selected suitable multifunction peripheral.

15. The multifunction peripheral selecting method of claim 14, wherein the selecting step selects, as the suitable multifunction peripheral, a multifunction peripheral in which every unit required for executing the designated function is supplied with electric power.

16. A multifunction peripheral selecting method for selecting a multifunction peripheral which is capable of controlling a power supply condition to a plurality of units and executing a plurality of functions each requiring different units, the multifunction selecting method comprising the steps of:
acquiring a power supply condition by each of the plurality of units of the multifunction peripheral;
receiving a designation of a function from a user;
selecting a suitable multifunction peripheral for executing the designated function from a plurality of the multifunction peripherals, which are subjects to be controlled, based on an acquisition result and previously stored required unit information indicating a correspondence relation between the function and units required for executing the function; and
determining the selected multifunction peripheral as an executing destination of a job corresponding to the designated function.

17. The multifunction peripheral selecting method of claim 16, wherein the selecting step selects, as the suitable multifunction peripheral, a multifunction peripheral in which every unit required for executing the designated function is supplied with electric power

18. A multifunction peripheral selecting method for selecting a multifunction peripheral which is capable of controlling a power supply condition to a plurality of units and executing of a plurality of functions each requiring different units, the multifunction peripheral selecting method comprising the steps of:
acquiring a power supply condition by each of the plurality of units of the multifunction peripheral:
receiving a designation of a function from a user;
selecting a suitable multifunction peripheral for executing the designated function from a plurality of the multifunction peripherals, which are subjects to be controlled, based on an acquisition result and previously stored required unit information indicating a correspondence relation between the function and units required for executing the function; and
notifying a user of each of the plurality of functions, and the selected multifunction peripheral by correlating to each of the plurality of functions.

19. The multifunction peripheral selecting method of claim 18, wherein the selecting step selects, as the suitable multifunction peripheral, a multifunction peripheral in which every unit required for executing the designated function is supplied with electric power.
